(19) United States
(12) Patent Application Publication
(10) Pub. No.: US 2025/0182985 A1
(43) Pub. Date: Jun. 5, 2025

(54) INPUT DEVICE

(71) Applicant: Alps Alpine Co., Ltd., Tokyo (JP)

(72) Inventors: Chiharu YUKAWA, Miyagi-ken (JP); Kaede MOCHIDA, Miyagi-ken (JP); Misuzu SUTO, Miyagi-ken (JP); Tsutomu KIYOSHI, Miyagi-ken (JP); Kazunari TAKAHASHI, Miyagi-ken (JP)

(21) Appl. No.: 19/045,078

(22) Filed: Feb. 4, 2025

Related U.S. Application Data
(63) Continuation of application No. PCT/JP2023/007666, filed on Mar. 1, 2023.

(30) Foreign Application Priority Data
Aug. 30, 2022 (JP) 2022-137274

(51) Int. Cl. H01H 13/14

(52) U.S. Cl. CPC H01H 13/14; H01H 2215/00

(57) ABSTRACT

An input device includes a housing, a movable member at least partially housed in the housing and reciprocably supported by the housing along a Z-axis direction, a soft magnetic member fixed to the housing, and a magnet fixed to the movable member facing the soft magnetic member in a Y-axis direction. The soft magnetic member includes a strong attraction portion where a magnetic attraction force between the magnet and the soft magnetic member is relatively strong and a weak attraction portion where a magnetic attraction force between the magnet and the soft magnetic member is relatively weak. The strong attraction portion is disposed so that one end is located at an inner side relative to one end of the magnet in the Z-axis direction, and the weak attraction portion includes a portion extending outward relative to the one end of the strong attraction portion in the Z-axis direction.

### CLAIM OF PRIORITY

This application is a Continuation of International Application No. PCT/JP2023/007666 filed on Mar. 1, 2023, which claims benefit of Japanese Patent Application No. 2022-137274 filed on Aug. 30, 2022. The entire contents of each application noted above are hereby incorporated by reference.

### BACKGROUND OF THE INVENTION

### 1. Field of the Invention

The present invention relates to an input device that can apply an operation reaction force.

### 2. Description of the Related Art

In the related art, an input device is known in which the slide member that has been pushed in is returned to its original position by the attraction force between the first magnet attached to the slide member (movable member) and the second magnet attached to the slide guide member (stationary member) and the return force of the switch portion (see JP 2017-045608 A1).

However, in the input device described above, the attraction force between the first magnet and the second magnet gradually decreases as the slide member is pushed in. Therefore, the input device described above cannot give a click feeling to the operator who pushes in the slide member. In addition, each of the first magnet and the second magnet may generate leakage flux, which may have a magnetic effect on other devices in the vicinity.

Therefore, it is desirable to provide an input device that can give a click feeling to the operator while suppressing magnetic effects on other devices.

### SUMMARY OF THE INVENTION

An input device according to an embodiment of the present disclosure capable of applying an operation reaction force includes a stationary member, a movable member at least partially housed in the stationary member and reciprocably supported by the stationary member along a first direction, a soft magnetic member fixed to the stationary member, and a magnetic field generating member fixed to the movable member so as to face the soft magnetic member in a second direction perpendicular to the first direction, wherein the soft magnetic member includes a strong attraction portion where a magnetic attraction force between the magnetic field generating member and the soft magnetic member is relatively strong and a weak attraction portion where a magnetic attraction force between the magnetic field generating member and the soft magnetic member is relatively weak, wherein the strong attraction portion is disposed so that one end of the strong attraction portion is located at an inner side relative to one end of the magnetic field generating member in the first direction, and wherein the weak attraction portion includes a portion extending outward relative to the one end of the strong attraction portion in the first direction.

### BRIEF DESCRIPTION OF THE DRAWINGS

FIG. 1 is a perspective view of the input device;

FIG. 2 is a exploded perspective view of the input device;

FIG. 3 is a cross-sectional view of the input device;

FIG. 4A is a perspective view of the linear motion device;

FIG. 4B is a left side view of the linear motion device;

FIG. 5 is a exploded perspective view of the linear motion device;

FIG. 6 is a perspective view of the movable member;

FIG. 7 is a right side view of the movable member housed in the casing body;

FIG. 8 is a exploded view of the linear motion device;

FIG. 9 is a perspective view of the left front ball set, the left front ball guide, and the left front rail;

FIG. 10 is a front view of the left front ball set, the left front ball guide, and the left front rail;

FIG. 11 is a cross-sectional view of the linear motion device;

FIG. 12 is a perspective view of the linear motion device;

FIG. 13A is a perspective view of the coil fixed to the housing;

FIG. 13B is a right side view of the coil fixed to the housing;

FIG. 14A is a cross-sectional view of the cover, the coil, and the magnet constituting the linear motion device;

FIG. 14B is a cross-sectional view of the cover, the coil, and the magnet constituting the linear motion device;

FIG. 15 is a right side view of the left cover, the left coil, and the magnet constituting the linear motion device;

FIG. 16 is a graph showing an example of the relationship between the operation reaction force, the stroke amount, and the current;

FIG. 17 is a graph showing another example of the relationship between the operation reaction force, the stroke amount, and the current;

FIG. 18 is a graph showing yet another example of the relationship between the operation reaction force, the stroke amount, and the current; and

FIG. 19 is a cross-sectional view of the linear motion device.

### DESCRIPTION OF THE PREFERRED EMBODIMENTS

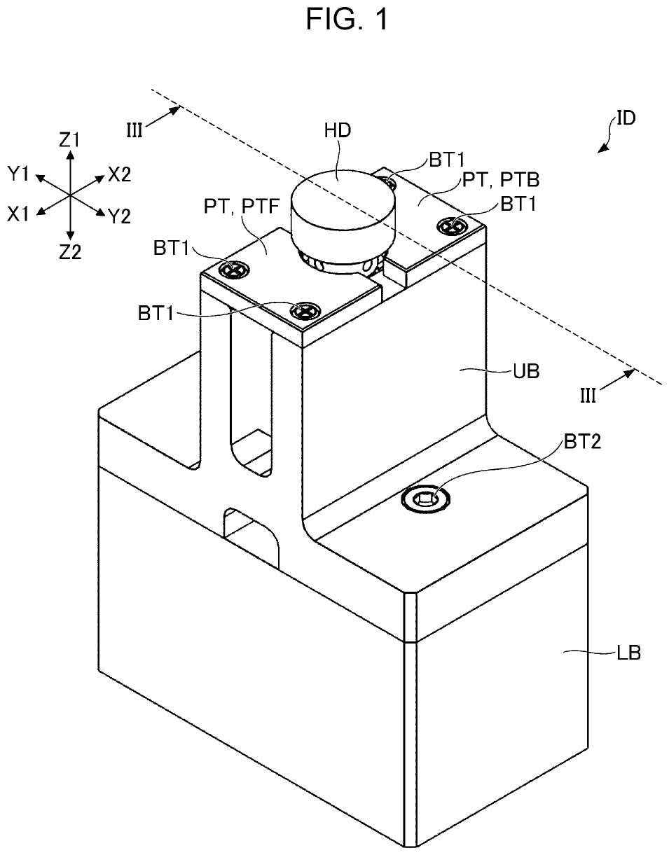

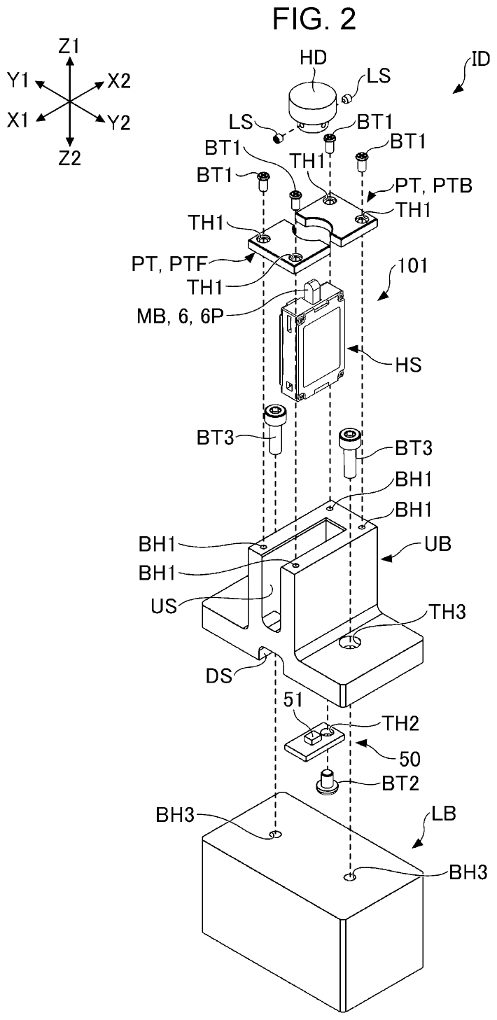

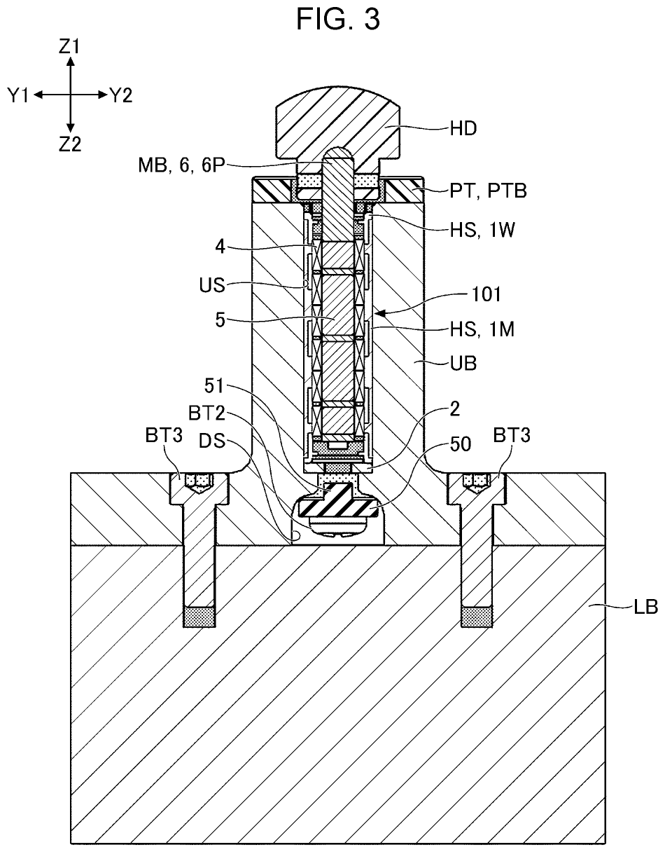

An input device ID according to the embodiment of the present disclosure is described with reference to the drawings. FIG. 1 is a perspective view of the input device ID and FIG. 2 is an exploded perspective view of the input device ID. FIG. 3 is a cross-sectional view of the input device ID. Specifically, FIG. 3 is a diagram when the cross-section of the input device ID in a plane parallel to the YZ plane including the cut line (dot-and-dash line III-III) shown in FIG. 1 is viewed from the X1 side.

X1 in each of FIGS. 1, 2, and 3 represents one direction of the direction of the X axis, which constitutes a three-dimensional Cartesian coordinate system, and X2 represents the other direction of the direction of the X axis. Y1 represents one direction of the direction of the Y axis, which constitutes a three-dimensional Cartesian coordinate system, and Y2 represents the other direction of the direction of the Y axis. Similarly, Z1 represents one direction of the direction of the Z axis, which constitutes a three-dimensional Cartesian coordinate system, and Z2 represents the other direction of the direction of the Z axis. In the present embodiment, the X1 side of the input device ID corresponds to the front (front side) of the input device ID, and the X2 side of the input device ID corresponds to the rear (back side) of the input device ID. The Y1 side of the input device ID corresponds to the left side of the input device ID, and the Y2 side of the input device ID corresponds to the right side of the input device ID. The Z1 side of the input device ID corresponds to the upper side of the input device ID, and the Z2 side of the input device ID corresponds to the lower side of the input device ID. The same applies to the other figures.

The input device ID is configured to be able to apply an operation reaction force. In the illustrated example, the input device ID is a push-pull switch that responds to each of the push operation and the pull operation, and mainly includes a head member HD, a lid member PT, a linear motion device 101, a circuit board 50, a position sensor 51, an upper block member UB, and a lower block member LB. The input device ID may be a push switch that responds only to a push operation, or a pull switch that responds only to a pull operation.

The head member HD is a member that can be pushed and pulled by the operator. In the illustrated example, the head member HD is a metal knob in a two-step cylindrical shape that can be grasped by the operator and pushed and pulled along the operating direction (Z-axis direction), and is fastened to a movable member MB (shaft 6P of a magnet holder 6) in the linear motion device 101 by a pair of set screws LS. However, the head member HD may be made of synthetic resin.

The lid member PT is configured to cover the top face of the upper block member UB. In the illustration, the lid member PT is a plate member made of metal and includes a front lid member PTF and a rear lid member PTB. However, the lid member PT may be made of another material such as synthetic resin. The front lid member PTF and the rear lid member PTB have the same shape and size. The lid member PT is fastened to the top face of the upper block member UB by a first bolt BT1 as a fastening member. Specifically, the first bolt BT1 is inserted into a first through hole TH1 formed in the lid member PT and screwed into a first bolt hole BH1 formed on the top face of the upper block member UB.

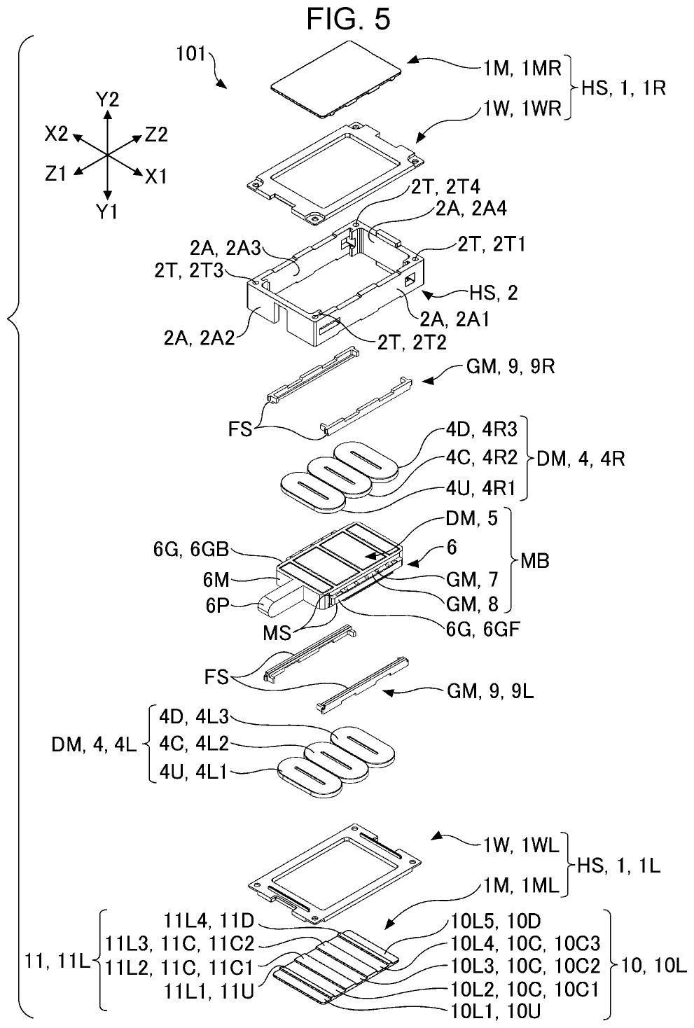

The linear motion device 101 is an example of an operation reaction force application device, and is configured to be able to apply a reaction force (operation reaction force) to the head member HD in response to the force (operation force) exerted on the head member HD by the operator. In the illustrated example, the linear motion device 101 includes a stationary member (housing HS) and the movable member MB (magnet holder 6). The linear motion device 101 is configured to be able to apply an operation reaction force to the head member HD by the magnetic attraction force acting between a soft magnetic member 1M attached to the stationary member (housing HS) and a magnetic field generating member (magnet 5) attached to the movable member MB (magnet holder 6). The linear motion device 101 is configured to be able to increase and decrease the operation reaction force by moving the magnet holder 6 up and down with respect to the housing HS using a drive means DM (see FIG. 5). The housing HS is fitted and secured in an upper recess US formed at the center of the upper block member UB. The lid member PT is fastened to the top face of the upper block member UB with its bottom face in contact with the top face of the housing HS. The lid member PT is fastened to the top face of the upper block member UB so that a cylindrical space can be formed between the front lid member PTF and the rear lid member PTB to accommodate the cylindrical portion at the lower stage of the head member HD.

The circuit board 50 is the circuit board to which the position sensor 51 is attached. In the illustrated example, the circuit board 50 is a rigid substrate with an insulator as a base material and is fastened to the upper block member UB by a second bolt BT2 as a fastening member. Specifically, the second bolt BT2 is inserted into a second through hole TH2 formed in the circuit board 50 and screwed into a second bolt hole (not visible in FIGS. 1 to 3) formed in the ceiling of a lower recess DS of the upper block member UB.

The position sensor 51 is configured to be able to detect the position of the movable member MB, which constitutes the linear motion device 101. In the illustrated example, the position sensor 51 is configured to be able to detect the position (height) of the movable member MB in the Z-axis direction by detecting the magnetic field generated by the magnet 5 (see FIG. 5) held by the magnet holder 6 that constitutes the movable member MB. Specifically, the position sensor 51 is composed of a giant magneto resistive effect (GMR) element and is configured to be able to detect the position of the movable member MB to which the magnet 5 is attached by measuring a voltage value that changes in accordance with the magnitude of the magnetic field, by the magnet 5, received by the position sensor 51. For example, the position sensor 51 is configured to output a larger voltage value as the N-pole portion of the magnet 5 approaches the position sensor. The position sensor 51 may be configured to output a larger voltage value as the S-pole portion of the magnet 5 approaches the position sensor, may be configured to output a smaller voltage value as the N-pole portion of the magnet 5 approaches the position sensor, or may be configured to output a smaller voltage value as the S-pole portion of the magnet 5 approaches the position sensor. The position sensor 51 may be configured to be able to detect the position of a lens holder 3 using another magnetoresistive element such as a semiconductor magneto resistive (SMR) element, an anisotropic magneto resistive (AMR) element, or a tunnel magneto resistive (TMR) element, or may be used to detect the position of the lens holder 3 using a Hall element or the like. The position sensor 51 may be configured to be able to detect the position of the movable member MB using a ultrasonic wave, infrared rays, or laser light.

The upper block member UB is configured to be able to hold the linear motion device 101 and the position sensor 51 in the desired position. The lower block member LB is configured to be able to hold the upper block member UB in the desired position. In the illustrated example, the upper block member UB and the lower block member LB are both made of metal. However, at least one of the upper block member UB and the lower block member LB may be made of another material such as synthetic resin. Specifically, the upper block member UB is fastened to the lower block member LB by a third bolt BT3 as a fastening member. More specifically, the third bolt BT3 is inserted into a third through hole TH3 formed in the upper block member UB and screwed into a third bolt hole BH3 formed in the top face of the lower block member LB.

The input device ID may be configured to determine whether a push operation is performed or a pull operation is performed based on the output of position sensor 51. Alternatively, the input device ID may be configured to derive the amount of pushing down or the amount of pulling up of the movable member MB based on the output of the position sensor 51. Alternatively, the input device ID may have a contact that contacts the movable member MB and is conductive when the movable member MB is pushed downwards (in the Z2 direction) by a predetermined distance, or may have a contact that contacts the movable member MB and is conductive when the movable member MB is pulled upwards (in the Z1 direction) by a predetermined distance.

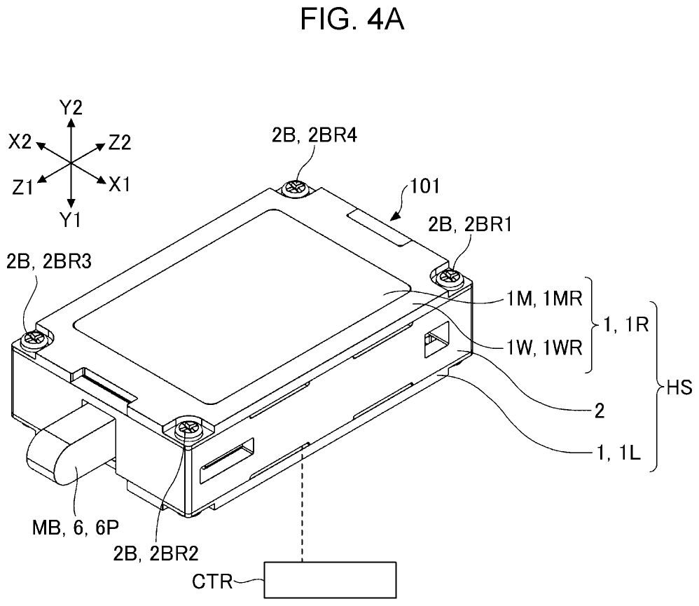

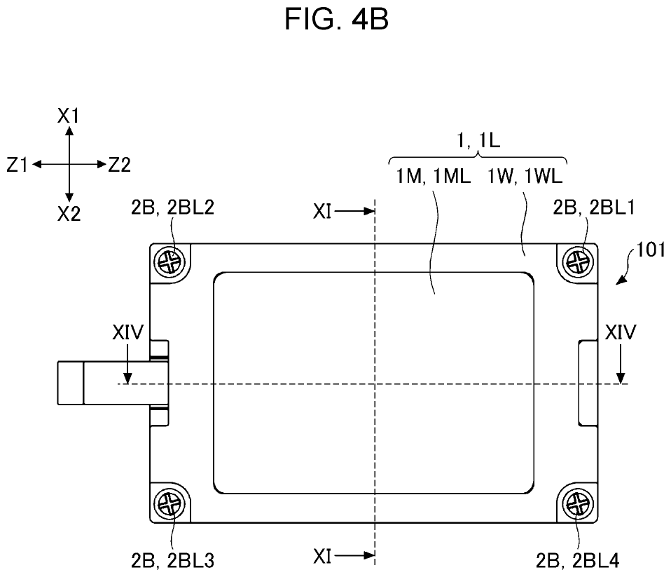

Next, referring to FIGS. 4A, 4B, and 5, the linear motion device 101 is described. FIG. 4A is a perspective view of the linear motion device 101, and FIG. 4B is a left side view of the linear motion device 101. FIG. 5 is an exploded perspective view of the linear motion device 101.

The linear motion device 101 includes the housing HS as a stationary member, the movable member MB that is housed in the housing HS, and a coil 4 that is attached to the housing HS. In the present embodiment, a control unit CTR is connected to the input terminal on a second insulating substrate (not shown) fixed to the housing HS via a conductor pattern formed on a first insulating substrate (not shown). The input terminal is connected to the coil 4 via the conductor pattern, and the like formed on the second insulating substrate. The dashed line in FIG. 4A schematically shows the electrical connection between the control unit CTR and the input terminal on the second insulating substrate (not shown).

As shown in FIG. 4A, the housing HS has an generally rectangular shape and is constructed so that the faces (left side face and right side face) parallel to the XZ plane have the largest area. In the present embodiment, the housing HS includes a cover 1 and a casing body 2.

The cover 1 includes a right cover 1R forming the right side face of the housing HS and a left cover 1L forming the left side face of the housing HS, as shown in FIG. 5. The right cover 1R and the left cover 1L are flat plate members. In the present embodiment, the right cover 1R and the left cover 1L have the same shape and size. In other words, the right cover 1R and the left cover 1L are configured as the same component.

The right cover 1R is formed to be symmetrical in front and back and vertically symmetrical. The same applies to the left cover 1L. The right cover 1R and the left cover 1L are disposed so as to be symmetrical in left and right.

Specifically, the right cover 1R includes a right soft magnetic member 1MR and a right frame 1WR. Similarly, the left cover 1L includes a left soft magnetic member 1ML and a left frame 1WL. In the following, the right soft magnetic member 1MR and the left soft magnetic member 1ML are also referred to as a soft magnetic member 1M, and the right frame 1WR and the left frame 1WL are also referred to as a frame 1W. Therefore, the cover 1 includes the soft magnetic member 1M and the frame 1W.

The soft magnetic member 1M is a member made of a soft magnetic material that is disposed away from the magnet 5 as the magnetic field generating member and magnetically attracted to the magnet 5. In the present embodiment, the soft magnetic member 1M is fixed to the frame 1W so as not to come into contact with the magnet 5 constituting the movable member MB and so as to magnetically hold the magnet 5 in a predetermined position. When the magnet 5 is displaced from the predetermined position, the attraction force between the magnet 5 and the soft magnetic member 1M based on the magnetic field (magnetic force) generated by the magnet 5 acts to pull the magnet 5 back to the predetermined position. The predetermined position is, for example, a position of the magnet 5 when the movable member MB is located at the center of the movable range. The configuration achieved by the combination of the magnet 5 and the soft magnetic member 1M in order to pull the magnet 5 back to a predetermined position by the attraction force between the magnet 5 and the soft magnetic member 1M is also referred to as a “magnetic spring”.

The frame 1W is a non-magnetic member for supporting the soft magnetic member 1M. In the present embodiment, the frame 1W is made of austenitic stainless steel. However, the frame 1W may be made of synthetic resin. In the illustrated example, the soft magnetic member 1M is bonded to the frame 1W by an adhesive.

The casing body 2 is formed to constitute part of the housing HS. In the present embodiment, the casing body 2 is a non-magnetic member and is made of austenitic stainless steel. However, the casing body 2 may be made of synthetic resin. Specifically, the casing body 2 includes a plate portion 2A of four plates which are formed in the shape of flat plates. More specifically, the plate portion 2A has a first plate portion 2A1 and a third plate portion 2A3 facing each other, and a second plate portion 2A2 and a fourth plate portion 2A4 perpendicular to each other of the first plate portion 2A1 and the third plate portion 2A3 and facing each other, as shown in FIG. 5.

The cover 1 is fastened to the casing body 2 by a fastening member. In the present embodiment, the fastening member is a male screw 2B configured to be operated with a Phillips screwdriver and to engage with each of female threaded holes 2T formed in the four corners of the casing body 2. The female threaded holes 2T formed in the four corners of the casing body 2 are formed to penetrate the corners of the casing body 2 along the Y-axis direction and include a first female threaded hole 2T1 to a fourth female threaded hole 2T4. The right cover 1R (right frame 1WR) is fastened to the right end of the casing body 2 by four right fastening members (first right male screw 2BR1 to fourth right male screw 2BR4 in FIG. 4A). Similarly, the left cover 1L (left frame 1WL) is fastened to the left end of the casing body 2 by four left fastening members (first left male screw 2BL1 to fourth left male screw 2BL4 in FIG. 4B).

Coil 4 is a component constituting the drive means DM. In the present embodiment, the coil 4 is a wound coil formed by winding a conducting wire whose surface is coated with an insulating material, and is configured to be fixed to the cover 1. For clarity, FIG. 5 omits illustration of the detailed winding state of the conducting wire. The same applies to the other figures illustrating the coil 4. The coil 4 may be a lamination coil or a thin-film coil. Specifically, the coil 4 includes a right coil 4R fixed to the left (Y1 side) face of the right cover 1R (right soft magnetic member 1MR) and a left coil 4L fixed to the right (Y2 side) face of the left cover 1L (left soft magnetic member 1ML). The right coil 4R includes a first right coil 4R1, a second right coil 4R2, and a third right coil 4R3, which are aligned along the Z-axis direction and connected in series, and the left coil 4L includes a first left coil 4L1, a second left coil 4L2, and a third left coil 4L3, which are aligned along the Z-axis direction and connected in series. In the following, the first right coil 4R1 and the first left coil 4L1 are also referred to as an upper coil 4U, the second right coil 4R2 and the second left coil 4L2 are referred to as a central coil 4C, and the third right coil 4R3 and the third left coil 4L3 are referred to as a lower coil 4D.

The control unit CTR is configured to be able to control the movement of the movable member MB. In the present embodiment, the control unit CTR is a device including an electronic circuit, a nonvolatile memory device, and the like, and is configured to be able to control the direction and the magnitude of the current flowing through the coil 4. The control unit CTR may be configured to control the direction and the magnitude of the current flowing through the coil 4 in response to a control command from an external device such as a computer, or may be configured to control the direction and the magnitude of the current flowing through the coil 4 without receiving a control command from an external device. In the present embodiment, although the control unit CTR is installed outside of the input device ID, it may be attached to the input device ID, or it may be installed inside the input device ID. The control unit CTR may be located outside the housing HS or inside the housing HS.

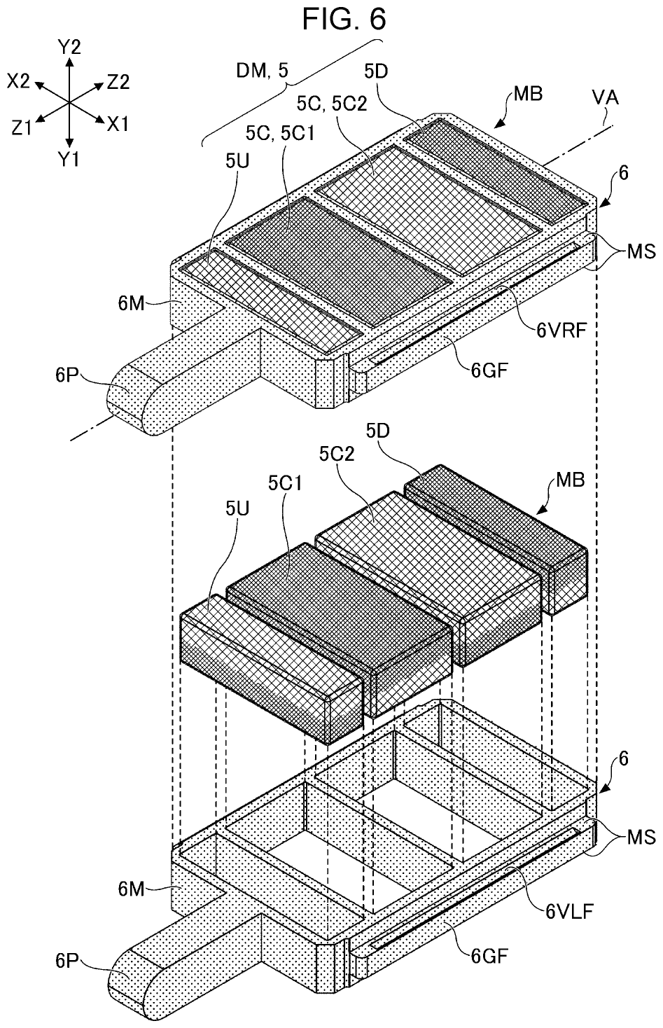

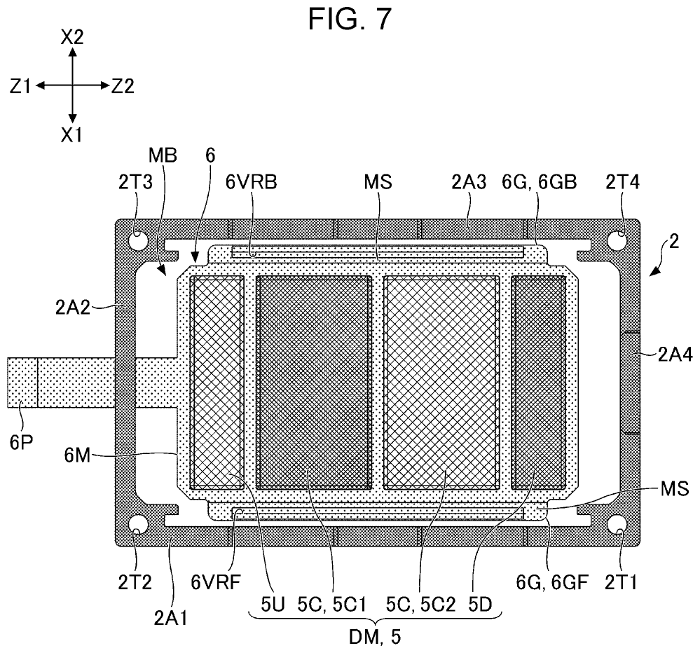

Next, referring to FIGS. 6 and 7, details of the movable member MB are described. FIGS. 6 and 7 are the external view of the movable member MB. Specifically, the upper diagram in FIG. 6 is a perspective view of the entire movable member MB, and the lower diagram in FIG. 6 is an exploded perspective view of the movable member MB. FIG. 7 is the right side view of the movable member MB housed in the casing body 2.

The movable member MB is configured to include the magnet 5 and the magnet holder 6. Specifically, the movable member MB is configured to be able to move with respect to the housing HS (casing body 2) along the axis VA (see the upper diagram in FIG. 6) extending in a predetermined direction (Z-axis direction).

The magnet 5 that is an example of a magnetic field generating member is a member constituting the drive means DM and is configured to be able to generate a magnetic field (magnetic flux). In the present embodiment, the magnet 5 is a combination of a plurality of permanent magnets and includes an upper magnet 5U, a central magnet 5C, and a lower magnet 5D. The central magnet 5C includes a first central magnet 5C1 and a second central magnet 5C2. The upper magnet 5U, the first central magnet 5C1, the second central magnet 5C2, and the lower magnet 5D are all permanent magnets magnetized to two poles along the Y-axis direction and are aligned along the Z-axis direction. In FIG. 6, for clarity, the N-pole portion of each of the upper magnet 5U, the first central magnet 5C1, the second central magnet 5C2, and the lower magnet 5D has a coarse cross pattern, while the S-pole portion has a fine cross pattern. The same applies to other figures that show the N-pole portion and the S-pole portion of the magnet 5 separately. The magnetic field generating member may consist of an electromagnet or the like.

Magnet holder 6 is configured to be able to hold the magnet 5. In the present embodiment, the magnet holder 6 is a generally rectangular frame-shaped member made of a non-magnetic material and has an overhang 6G, a body 6M, and the shaft 6P. The overhang 6G is formed to protrude from the body 6M in the front-back direction (X-axis direction). Specifically, the overhang 6G includes a rear overhang 6GB that protrudes backward (X2 direction) and a front overhang 6GF that protrudes forward (X1 direction). The shaft 6P is formed to protrude upward (in the Z1 direction) from the body 6M. Specifically, the magnet holder 6 is configured to be able to hold the upper magnet 5U, the first central magnet 5C1, the second central magnet 5C2, and the lower magnet 5D at generally equal intervals along the Z-axis direction.

The drive means DM is an example of a driving force generator and is configured to be able to move the movable member MB along the axis VA with respect to the stationary member. In the present embodiment, the drive means DM includes the coil 4 and the magnet 5, and is configured to be able to move the movable member MB (magnet 5) along the axis VA using the Lorentz force according to the direction and the magnitude of the current supplied to the coil 4 through the control unit CTR.

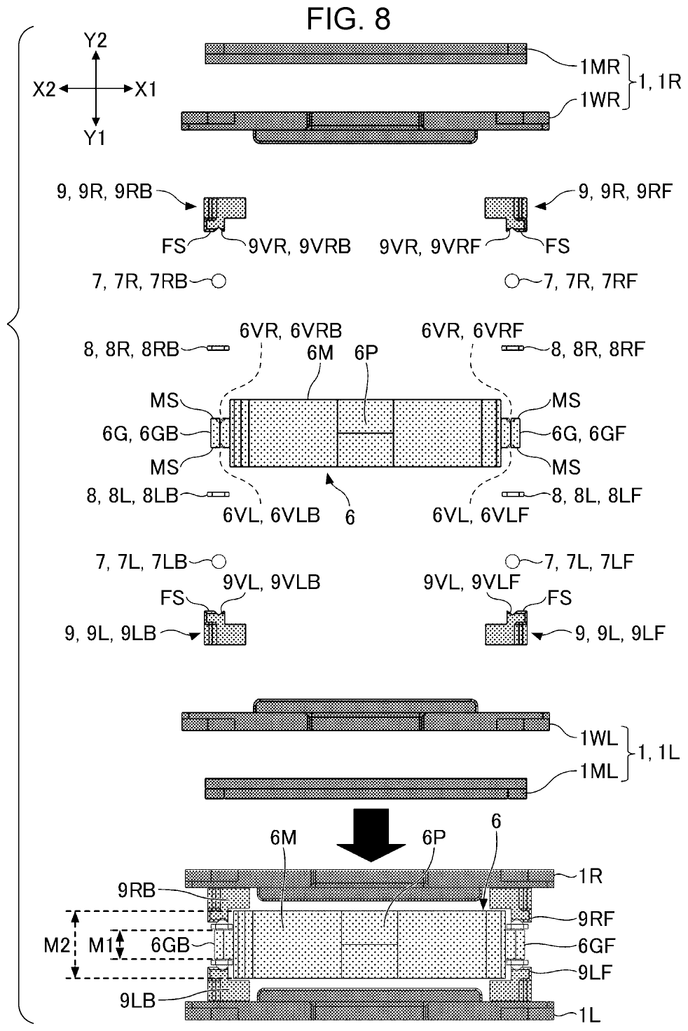

Next, referring to FIG. 8, a guiding means GM is described. FIG. 8 is an exploded view of the linear motion device 101. In FIG. 8, for clarity, illustration of components other than the cover 1, the magnet holder 6, a ball set 7, a ball guide 8, and a rail 9 is omitted. Specifically, the upper diagram in FIG. 8 (located above the block arrow) is a top view of the cover 1, the magnet holder 6, the ball set 7, the ball guide 8, and the rail 9 in their disassembled state. The lower diagram in FIG. 8 (located below the block arrow) is a top view of the cover 1, the magnet holder 6, the ball set 7, the ball guide 8, and the rail 9 in the assembled state. In FIG. 8, for clarity, the right cover 1R and the left cover 1L have a fine dot pattern, the rail 9 has a coarse dot pattern, and the magnet holder 6 has an further coarser dot pattern.

The guiding means GM is configured to be able to move and guide the movable member MB along the vertical direction (Z-axis direction) in the housing HS. In the present embodiment, the guiding means GM includes the ball set 7, the ball guide 8, and the rail 9, as shown in FIG. 5. The guiding means GM is configured so that the overhang 6G formed in the magnet holder 6 constituting the movable member MB is sandwiched between the pair of rails 9 disposed left and right via the ball set 7, and is guided freely in the Z-axis direction by the pair of rails 9.

Specifically, the overhang 6G formed in the magnet holder 6 includes the front overhang 6GF extending in the Z-axis direction facing the first plate portion 2A1 of the casing body 2 and the rear overhang 6GB extending in the Z-axis direction facing the third plate portion 2A3 of the casing body 2. The dimension M1 of the overhang 6G (rear overhang 6GB) in the left-right direction (Y-axis direction) is smaller than the dimension M2 of the body 6M in the left-right direction (Y-axis direction).

The rail 9 is part of the stationary member, and includes a right rail 9R that is located between the right cover 1R and the overhang 6G and a left rail 9L, that is located between the left cover 1L and the overhang 6G, as shown in FIG. 8. The right rail 9R includes a right front rail 9RF extending in the Z-axis direction facing the first plate portion 2A1 of the casing body 2 and a right rear rail 9RB extending in the Z-axis direction facing the third plate portion 2A3 of the casing body 2. Similarly, the left rail 9L includes a left front rail 9LF extending in the Z-axis direction facing the first plate portion 2A1 of the casing body 2 and a left rear rail 9 LB extending in the Z-axis direction facing the third plate portion 2A3 of the casing body 2.

Ball set 7 is an example of a rolling member and consists of a plurality of spherical balls. Specifically, the ball set 7 includes a right ball set 7R that is located between the right rail 9R and the overhang 6G and a left ball set 7L that is located between the left rail 9L and the overhang 6G, as shown in the upper diagram in FIG. 8. The right ball set 7R includes a right front ball set 7RF that is located between the right front rail 9RF and the front overhang 6GF and a right rear ball set 7RB that is located between the right rear rail 9RB and the rear overhang 6GB. Similarly, the left ball set 7L includes a left front ball set 7LF located between the left front rail 9LF and the front overhang 6GF, and a left rear ball set 7 LB located between the left rear rail 9 LB and the rear overhang 6GB.

The ball guide 8 is a member that maintains distances between the plurality of balls constituting the ball set 7. The ball guide 8 may be omitted. Ball guide 8 includes a right ball guide 8R that maintains distances between the plurality of balls constituting the right ball set 7R and a left ball guide 8L that maintains distances between the plurality of balls constituting the left ball set 7L. The right ball guide 8R includes a right front ball guide 8RF that maintains distances between the plurality of balls constituting the right front ball set 7RF and a right rear ball guide 8RB that maintains distances between the plurality of balls constituting the right rear ball set 7RB. Similarly, the left ball guide 8L includes a left front ball guide 8LF that maintains distances between the plurality of balls constituting the left front ball set 7LF and a left rear ball guide 8 LB that maintains distances between the plurality of balls constituting the left rear ball set 7 LB.

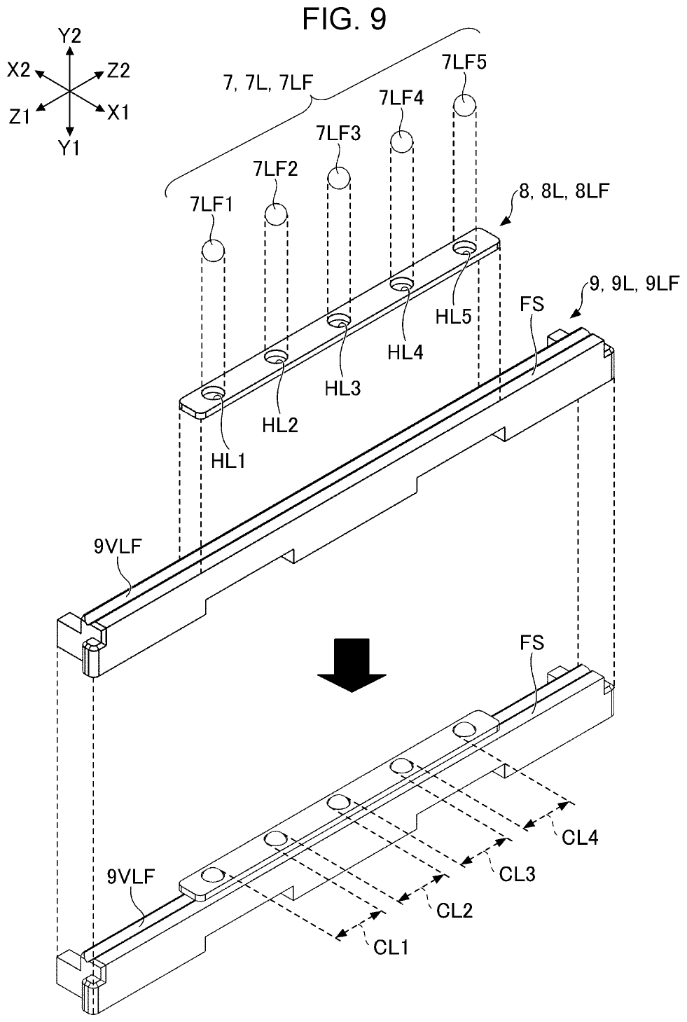

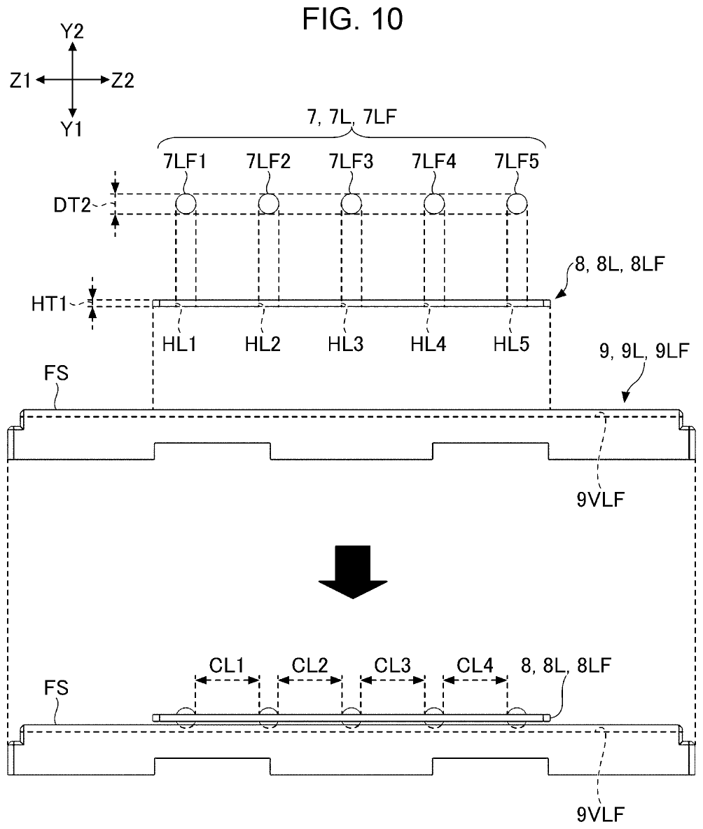

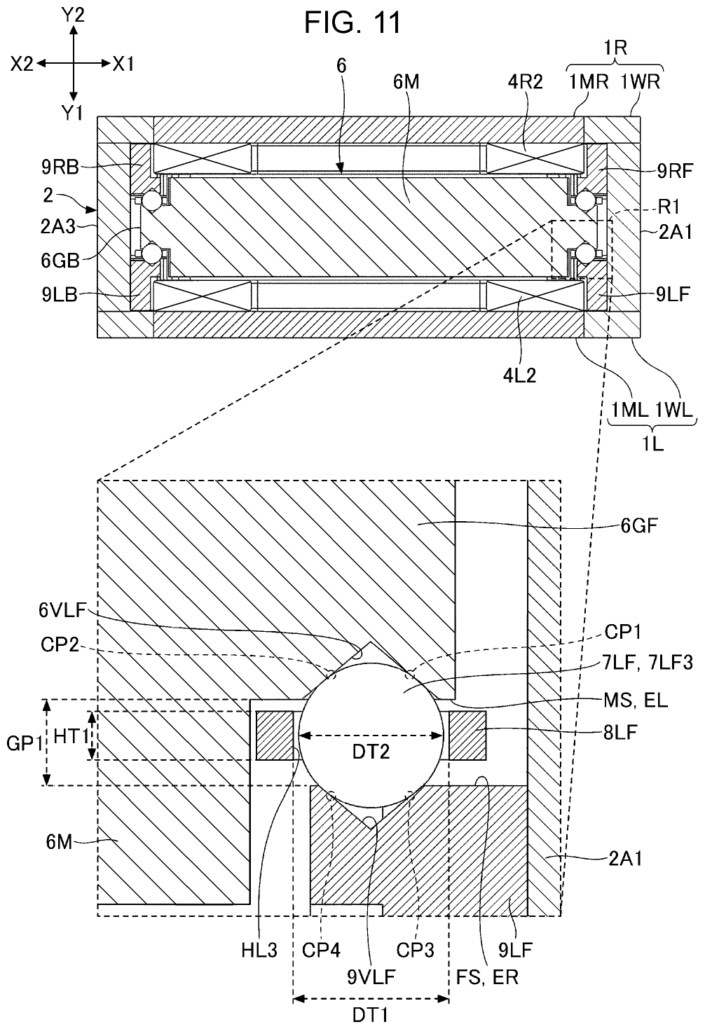

Next, referring to FIGS. 9 to 11, the relationship between the ball set 7, the ball guide 8, and the rail 9 are described. FIG. 9 is a perspective view of the left front ball set 7LF, the left front ball guide 8LF, and the left front rail 9LF. Specifically, the upper diagram in FIG. 9 (located above the block arrow) is an exploded perspective view of the left front ball set 7LF, the left front ball guide 8LF, and the left front rail 9LF, and the lower diagram in FIG. 9 (located below the block arrow) is an assembled perspective view of the left front ball set 7LF, the left front ball guide 8LF, and the left front rail 9LF. FIG. 10 is a front view of the left front ball set 7LF, the left front ball guide 8LF, and the left front rail 9LF. Specifically, the upper diagram in FIG. 10 (located above the block arrow) is an exploded front view of the left front ball set 7LF, the left front ball guide 8LF, and the left front rail 9LF, and the lower diagram in FIG. 10 (located below the block arrow) is an assembled front view of the left front ball set 7LF, the left front ball guide 8LF and the left front rail 9LF. FIG. 11 is a cross-sectional view of the linear motion device 101. Specifically, the upper diagram in FIG. 11 is a diagram when the cross-section of the linear motion device 101 in a plane parallel to the XZ plane including the dot-and-dash line XI-XI shown in FIG. 4B is viewed from the Z1 side as indicated by the arrow. The lower diagram in FIG. 11 is an enlarged view of a range R1 enclosed by the dashed line in the upper diagram in FIG. 11. The following description referring to FIGS. 9 to 11 is related to the positional relationship between the left front ball set 7LF, the left front ball guide 8LF and the left front rail 9LF, and the same applies to the positional relationship between the right front ball set 7RF, the right front ball guide 8RF and the right front rail 9RF, the positional relationship between the right rear ball set 7RB, the right rear ball guide 8RB and the right rear rail 9RB, and the positional relationship between the left rear ball set 7 LB, the left rear ball guide 8 LB and the left rear rail 9 LB.

Specifically, the left front ball set 7LF includes five balls (first ball 7LF1 to five ball 7LF5), as shown in FIGS. 9 and 10. The five balls (first ball 7LF1 to five ball 7LF5) are disposed in the five through holes (first through hole HL1 to fifth through hole HL5) formed in the left front ball guide 8LF.

The five balls (first ball 7LF1 to five ball 7LF5) are disposed between a V-groove 6VLF formed on the left end face of the front overhang 6GF of the magnet holder 6 (see FIG. 8) and a V-groove 9VLF formed on the right end face of the left front rail 9LF. In this case, a left end face EL of the front overhang 6GF serves as a movable end face MS and a right end face ER of the left front rail 9LF serves as a fixed end face FS.

The left front ball guide 8LF is configured so that the thickness HT1 in the Y-axis direction is smaller than the respective diameters DT2 of the first ball 7LF1 to the five ball 7LF5, as shown in FIGS. 10 and 11. Specifically, as shown in the lower diagram in FIG. 11, the thickness HT1 of the left front ball guide 8LF is configured to be smaller than the gap GP1 between the left end face EL of the front overhang 6GF and the right end face ER of the left front rail 9LF when the left front ball set 7LF is sandwiched between the left end face EL of the front overhang 6GF and the right end face ER of the left front rail 9LF. The diameter DT1 of each of the five through holes (first through hole HL1 to fifth through hole HL5) is configured to be slightly larger than the diameter DT2 of each of the five balls (first ball 7LF1 to five ball 7LF5), as shown in the lower diagram in FIG. 11. However, the diameter DT1 of each of the five through holes (first through hole HL1 to fifth through hole HL5) may be configured to be slightly smaller than the diameter DT2 of each of the five balls (first ball 7LF1 to five ball 7LF5).

Each ball constituting the left front ball set 7LF is sandwiched between the V-groove 6VLF and the V-groove 9VLF so that the ball contacts the V-groove 6VLF at two contact points and contacts the V-groove 9VLF at two contact points, as shown in the lower diagram in FIG. 11. The lower diagram in FIG. 11 shows a state in which the third ball 7LF3 is in contact with the V-groove 6VLF at a contact point CP1 and a contact point CP2, and is in contact with the V-groove 9VLF at a contact point CP3 and a contact point CP4.

In the illustrated example, the five through holes (first through hole HL1 to fifth through hole HL5) in the left front ball guide 8LF are spaced so that the distance between two adjacent balls of the five balls (first ball 7LF1 to five ball 7LF5) constituting the left front ball set 7LF is the same. Specifically, as shown in FIGS. 9 and 10, the left front ball guide 8LF is configured so that a distance CL1 between the first through hole HL1 and the second through hole HL2, a distance CL2 between the second through hole HL2 and the third through hole HL3, a distance CL3 between the third through hole HL3 and the fourth through hole HL4, and a distance CL4 between the fourth through hole HL4 and the fifth through hole HL5 are all equal.

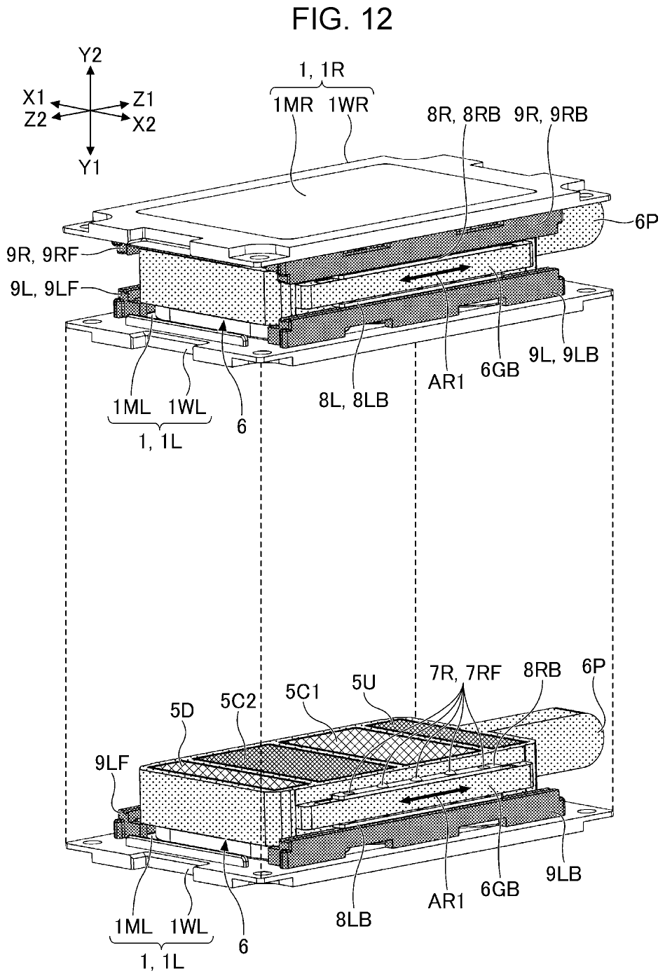

Next, referring to FIG. 12, details of the guiding means GM are described. FIG. 12 is a perspective view of the linear motion device 101. In FIG. 12, for clarity, illustration of components other than the cover 1, the magnet 5, the magnet holder 6, the ball set 7, the ball guide 8, and the rail 9 is omitted. Specifically, the upper diagram in FIG. 12 is a perspective view of the cover 1, the magnet 5, the magnet holder 6, the ball set 7, the ball guide 8, and the rail 9 in the assembled state. The lower diagram in FIG. 12 is a perspective view of the left cover 1L, the magnet 5, the magnet holder 6, the ball set 7, the left ball guide 8L, and the left rail 9L in the assembled state. In FIG. 12, for clarity, the magnet holder 6 has a coarse dot pattern and the rail 9 has a fine dot pattern.

The distal end (left end) of the right front rail 9RF and the distal end (right end) of the left front rail 9LF are assembled so as to face each other with the front overhang 6GF interposed therebetween, as shown in FIG. 8, and the distal end (left end) of the right rear rail 9RB and the distal end (right end) of the left rear rail 9 LB are assembled so as to face each other with the rear overhang 6GB interposed therebetween, as shown in FIG. 8.

Specifically, as shown in the upper diagram in FIG. 12, the distal end of the right rear rail 9RB is disposed to face the right end face of the rear overhang 6GB with a small distance therebetween, and the distal end of the left rear rail 9 LB is disposed to face the left end face of the rear overhang 6GB with a small distance therebetween. In other words, the rear overhang 6GB is configured to have the same shape as the space formed between the distal end of the right rear rail 9RB and the distal end of the left rear rail 9 LB. Specifically, the rear overhang 6GB is formed as one generally rectangular-shaped protrusion that extends continuously over most of the entire length of the magnet holder 6 in the longitudinal direction. However, the rear overhang 6GB may be a combination of a plurality of protrusions disposed intermittently along the longitudinal direction of the magnet holder 6. The same applies to the front overhang 6GF. In the illustrated example, the magnet holder 6 is symmetrical in front and back. In other words, the front overhang 6GF and the rear overhang 6GB are formed to have the same shape and size. However, the front overhang 6GF and the rear overhang 6GB may have different shapes.

As described above, the overhang 6G is configured to be able to move between the right rail 9R and the left rail 9L in the direction indicated by the two-way arrow ARI in FIG. 12. Specifically, the overhang 6G is configured so that the right ball set 7R is sandwiched between a V-groove 6VR (V-groove 6VRB and V-groove 6VRF in FIG. 8) formed at the right end face, the V-groove 6VR serving as the movable end face MS, and a V-groove 9VR (V-groove 9VRB and V-groove 9VRF in FIG. 8) formed at the distal end face (left end face) of the right rail 9R, the V-groove 9VR serving as the fixed end face FS. The overhang 6G is configured so that the left ball set 7L is sandwiched between the V-groove 6VL (V-groove 6VLB and V-groove 6VLF in FIG. 8) formed at the left end face, the V-groove 6VL serving as the movable end face MS, and the V-groove 9VL (V-groove 9VLB and V-groove 9VLF in FIG. 8) formed at the distal end face (right end face) of the left rail 9L, the V-groove 9VL serving as the fixed end face FS. The overhang 6G is configured to be able to move in the vertical direction (Z-axis direction) while allowing the right ball set 7R to roll between the V-groove 6VR and the V-groove 9VR and allowing the left ball set 7L to roll between the V-groove 6VL and the V-groove 9VL.

This configuration allows the magnet holder 6 to move smoothly in the vertical direction (Z-axis direction) while restricting movement in the front-back direction (X-axis direction) and the left-right direction (Y-axis direction).

However, the overhang 6G of the magnet holder may be configured to be in direct contact with the rail 9 and slide on the rail 9. In this case, the ball set 7 and the ball guide 8 may be omitted. The rail 9 may be integrated into the cover 1.

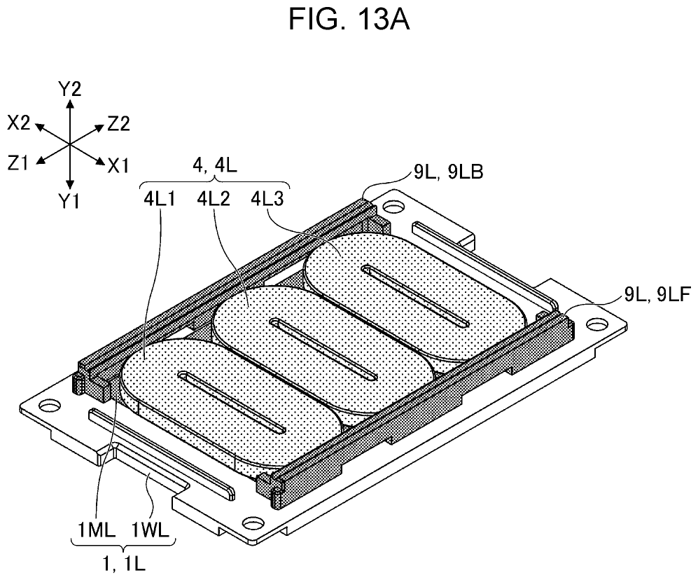

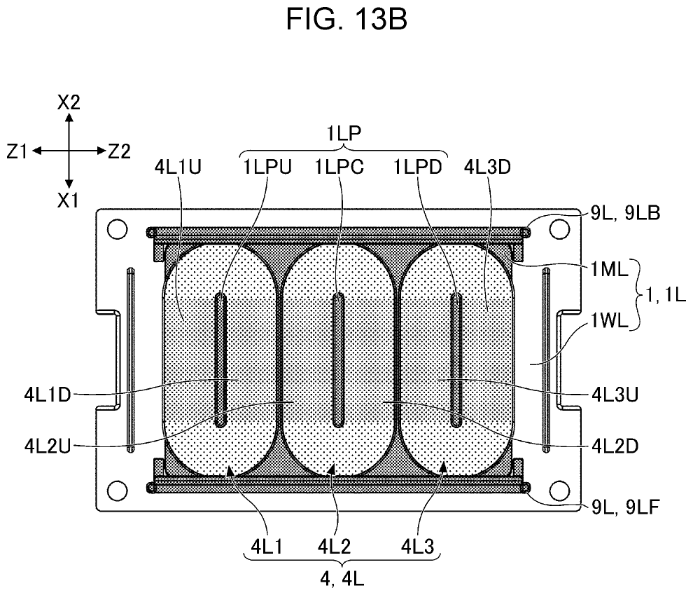

Next, referring to FIGS. 13A, 13B, 14A, 14B, and 15, the details of the drive means DM are described. FIGS. 13A and 13B show a detailed view of the coil 4 fixed to the housing HS. Specifically, FIG. 13A is a perspective view of a left coil 4L fixed to the left cover 1L. FIG. 13B shows the right side view of the left coil 4L fixed to the left cover 1L. In FIGS. 13A and 13B, for clarity, the left coil 4L has a coarse dot pattern and the left soft magnetic member 1ML and left rail 9L have a fine dot pattern.

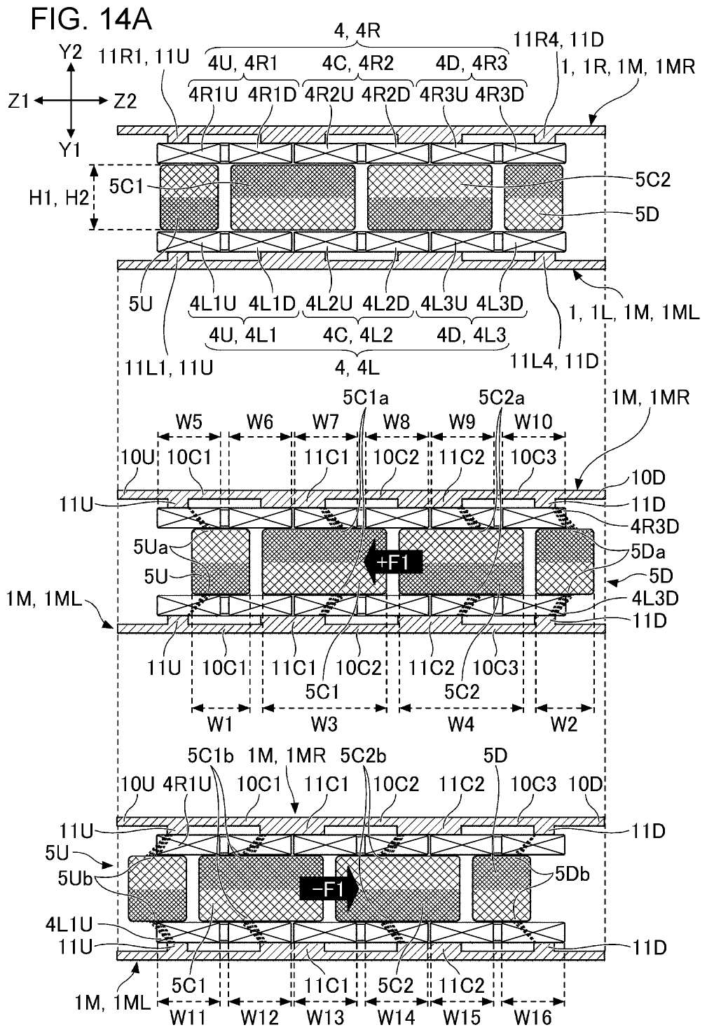

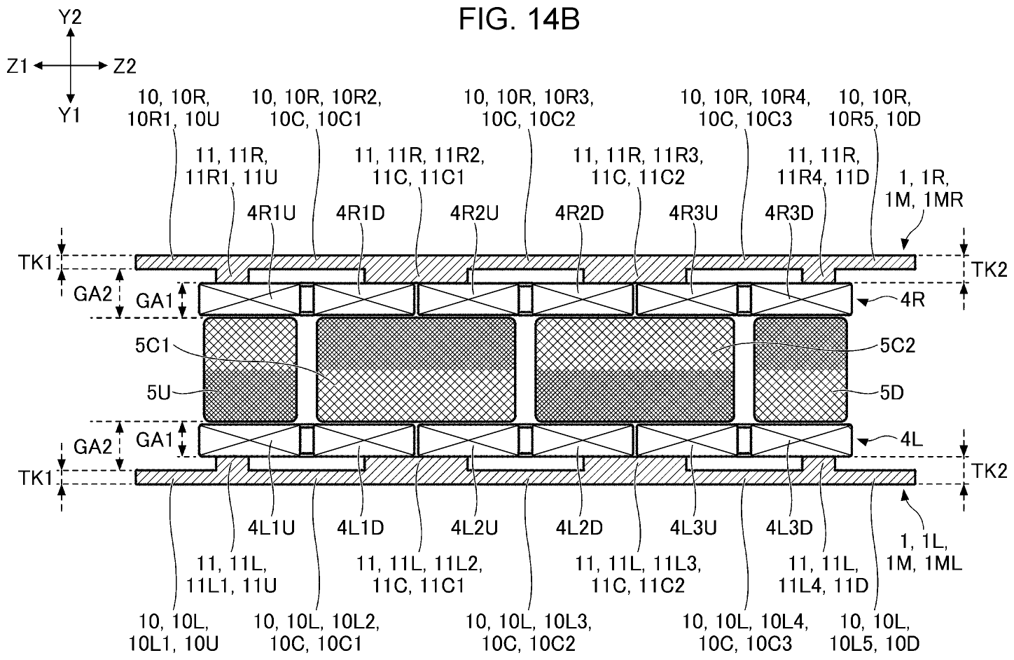

FIGS. 14A and 14B are diagrams when the cross-section of the linear motion device 101 in a plane parallel to the YZ plane including the dot-and-dash line XIV-XIV shown in FIG. 4B is viewed from the X1 side as indicated by the arrow. Specifically, the upper diagram in FIG. 14A and FIG. 14B are cross-sectional views of the cover 1 (soft magnetic member 1M), the coil 4, and the magnet 5 when the movable member MB (magnet 5) is disposed at the center of the movable range. The central diagram in FIG. 14A is a cross-sectional view of the cover 1 (soft magnetic member 1M), the coil 4, and the magnet 5 when the movable member MB (magnet 5) moves downward (in the Z2 direction) from the center of the movable range. The lower diagram in FIG. 14A is a cross-sectional view of the cover 1 (soft magnetic member 1M), the coil 4, and the magnet 5 when the movable member MB (magnet 5) moves upward (in the Z1 direction) from the center of the movable range. In FIGS. 14A and 14B, for clarity, illustration of components (including the frame 1W) other than the soft magnetic member 1M, the coil 4, and the magnet 5 is omitted.

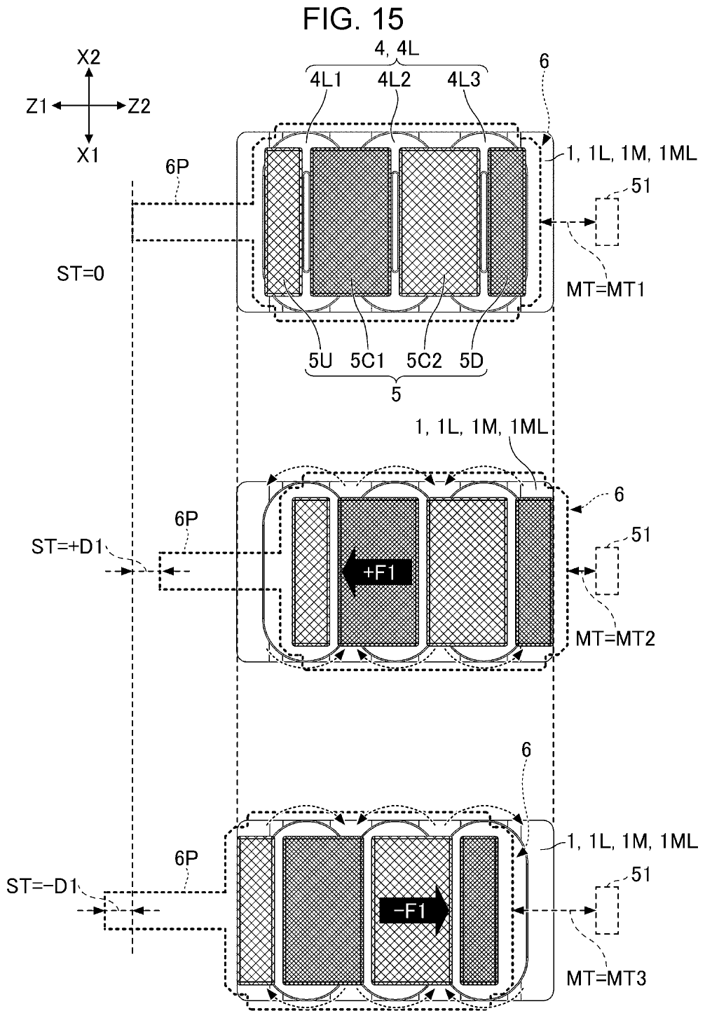

FIG. 15 is the right side view of the magnet 5 that can move vertically (Z-axis direction) on the right side of the left coil 4L (left soft magnetic member 1ML) fixed to the left cover 1L (left soft magnetic member 1ML). Specifically, the upper diagram in FIG. 15 is the right side view of the left soft magnetic member 1ML, the left coil 4L, and the magnet 5 when the movable member MB (magnet 5) is located at the center of the movable range, and the state shown in the upper diagram in FIG. 15 corresponds to that shown in the upper diagram in FIG. 14A. The central diagram in FIG. 15 is the right side view of the left soft magnetic member 1ML, the left coil 4L, and the magnet 5 when the movable member MB (magnet 5) moves downward (in the Z2 direction) from the center of the movable range, and the state shown in the central diagram in FIG. 15 corresponds to that shown in the central diagram in FIG. 14A. The lower diagram in FIG. 15 is the right side view of the left soft magnetic member 1ML, the left coil 4L, and the magnet 5 when the movable member MB (magnet 5) moves upward (in the Z1 direction) from the center of the movable range, and the state shown in the lower diagram in FIG. 15 corresponds to that shown in the lower diagram in FIG. 14A. In FIG. 15, for clarity, the magnet holder 6 and the position sensor 51 are shown in dashed lines and illustration of the left frame 1WL is omitted.

The coil 4, one of the components of the drive means DM, includes the right coil 4R fixed to the left (Y1 side) face of the right cover 1R and the left coil 4L fixed to the right (Y2 side) face of the left cover 1L, as shown in FIG. 5.

The left coil 4L includes three coils (first left coil 4L1, second left coil 4L2, and third left coil 4L3) that are fixed to the right face (Y2 side face) of the left cover 1L with an adhesive, as shown in FIGS. 13A and 13B. The following description which refers to FIGS. 13A and 13B relates to the left coil 4L, but the same applies to the right coil 4R. This is because the right cover 1R and the left cover 1L have the same shape and size, and the right coil 4R and the left coil 4L have the same shape and size.

Each of the three coils constituting the left coil 4L is wound around a left internal space 1LP, as shown in FIG. 13B. Specifically, the first left coil 4L1 is wound around an upper left internal space 1LPU, the second left coil 4L2 is wound around a central left internal space 1LPC, and the third left coil 4L3 is wound around a lower left internal space 1LPD.

The first left coil 4L1 includes an upper bundle wire portion 4L1U located above (Z1 side) the upper left internal space 1LPU and extending along the upper left internal space 1LPU and a lower bundle wire portion 4L1D located below (Z2 side) the upper left internal space 1LPU and extending along the upper left internal space 1LPU. The bundle wire portion refers to a portion where the conducting wires constituting coil 4 extend along the front-back direction (X-axis direction).

In FIG. 13B, for clarity, the upper bundle wire portion 4L1U and the lower bundle wire portion 4L1D in the first left coil 4L1 have a dot pattern finer than a dot pattern on the other parts in the first left coil 4L1. The same applies to the second left coil 4L2 and the third left coil 4L3.

The second left coil 4L2 includes an upper bundle wire portion 4L2U located above (Z1 side) the central left internal space 1LPC and extending along the central left internal space 1LPC and a lower bundle wire portion 4L2D located below (Z2 side) the central left internal space 1LPC, and extending along the central left internal space 1LPC.

Similarly, the third left coil 4L3 includes an upper bundle wire portion 4L3U located above (Z1 side) the lower left internal space 1LPD and extending along the lower left internal space 1LPD and a lower bundle wire portion 4L3D located below (Z2 side) the lower left internal space 1LPD and extending along the lower left internal space 1LPD.

The upper bundle wire portion 4L1U and the lower bundle wire portion 4LID of the first left coil 4L1 are the portions through which the magnetic flux generated by the magnet 5 passes, that is, the portions that generate the driving force based on the Lorentz force in order to move the movable member MB in the left-right direction. The same applies to the upper bundle wire portion 4L2U and the lower bundle wire portion 4L2D of the second left coil 4L2, and the upper bundle wire portion 4L3U and the lower bundle wire portion 4L3D of the third left coil 4L3.

The magnet 5, another one of the components of the drive means DM, is vertically (Z-axis direction) movably disposed in the space between the right coil 4R and the left coil 4L, as shown in FIG. 14A. Specifically, the magnet 5 includes the upper magnet 5U, the first central magnet 5C1, the second central magnet 5C2, and the lower magnet 5D. The upper magnet 5U, the first central magnet 5C1, the second central magnet 5C2, and the lower magnet 5D are held in a state with a predetermined distance therebetween by magnet holder 6 (not shown in FIG. 14A).

In the present embodiment, the upper magnet 5U has a width W1 approximately same as a width W2 of the lower magnet 5D, as shown in the central diagram in FIG. 14A. The first central magnet 5C1 has a width W3 approximately same as a width W4 of the second central magnet 5C2. The upper magnet 5U has a width W1 that is generally half a width W3 of the first central magnet 5C1.

In the present embodiment, the six coils that make up coil 4 are configured to have the same shape and the same size. That is, as shown in the central figure and the lower diagram in FIG. 14A, a width W5 of an upper bundle wire portion 4R1U of the first right coil 4R1, a width W6 of a lower bundle wire portion 4RID of the first right coil 4R1, a width W7 of an upper bundle wire portion 4R2U of the second right coil 4R2, a width W8 of a lower bundle wire portion 4R2D of the second right coil 4R2, a width W9 of an upper bundle wire portion 4R3U of the third right coil 4R3, a width W10 of a lower bundle wire portion 4R3D of the third right coil 4R3, a width W11 of the upper bundle wire portion 4L1U of the first left coil 4L1, a width W12 of the lower bundle wire portion 4LID of the first left coil 4L1, a width W13 of the upper bundle wire portion 4L2U of the second left coil 4L2, a width W14 of the lower bundle wire portion 4L2D of the second left coil 4L2, a width W15 of the upper bundle wire portion 4L3U of the third left coil 4L3, and a width W16 of the lower bundle wire portion 4L3D of the third left coil 4L3 are all the same size.

The upper magnet 5U has the width W1 approximately same as the width W5 of the upper bundle wire portion 4R1U of the first right coil 4R1. The first central magnet 5C1 has the width W3 approximately same as the sum of the width W6 of the lower bundle wire portion 4RID of the first right coil 4R1 and the width W7 of the upper bundle wire portion 4R2U of the second right coil 4R2.

When the movable member MB (magnet 5) is located at the center of the movable range, as shown in the upper diagram in FIG. 14A, the upper magnet 5U is disposed so that the N-pole portion (right side portion) faces the upper bundle wire portion 4R1U of the first right coil 4R1 and the S-pole portion (left side portion) faces the upper bundle wire portion 4L1U of the first left coil 4L1. The first central magnet 5C1 is disposed so that the S-pole portion (right side portion) faces each of the lower bundle wire portion 4RID of the first right coil 4R1 and the upper bundle wire portion 4R2U of the second right coil 4R2, and the N-pole portion (left side portion) faces each of the lower bundle wire portion 4LID of the first left coil 4L1 and the upper bundle wire portion 4L2U of the second left coil 4L2. The second central magnet 5C2 is disposed so that the N-pole portion (right side portion) faces each of the lower bundle wire portion 4R2D of the second right coil 4R2 and the upper bundle wire portion 4R3U of the third right coil 4R3, and the S-pole portion (left side portion) faces each of the lower bundle wire portion 4L2D of the second left coil 4L2 and the upper bundle wire portion 4L3U of the third left coil 4L3. The lower magnet 5D is disposed so that the S-pole portion (right side portion) faces the lower bundle wire portion 4R3D of the third right coil 4R3 and the N-pole portion (left side portion) faces the lower bundle wire portion 4L3D of the third left coil 4L3.

When the current flows in the left coil 4L as shown by the dashed arc arrow in the central diagram in FIG. 15, the movable member MB (magnet 5) moves downward (in the Z2 direction), while being guided by the guiding means GM. Specifically, when the current flows counterclockwise when viewed from right side to the first left coil 4L1, the current flows clockwise when viewed from right side to the second left coil 4L2, and the current flows counterclockwise when viewed from right side to the third left coil 4L3, the movable member MB (magnet 5) moves downward (in the Z2 direction).

This is because the Lorentz force acts on charged particles moving in the conducting wire that constitutes the left coil 4L fixed to the left cover 1L, and the reaction force causes the upper magnet 5U, the first central magnet 5C1, the second central magnet 5C2, and the lower magnet 5D as the magnet 5 to move downward (in the Z2 direction).

Similarly, when the current flows in the left coil 4L as shown by the dashed arc arrow in the lower diagram in FIG. 15, the movable member MB (magnet 5) moves upward (in the Z1 direction) while being guided by the guiding means GM. Specifically, when the current flows clockwise when viewed from right side to the first left coil 4L1, the current flows counterclockwise when viewed from right side to the second left coil 4L2, and the current flows clockwise when viewed from right side to the third left coil 4L3, the movable member MB (magnet 5) moves upward (in the Z1 direction).

The soft magnetic member 1M includes the right soft magnetic member 1MR that is located outside (Y2 side) of the right coil 4R and the left soft magnetic member 1ML that is located outside (Y1 side) of the left coil 4L, as shown in FIG. 14B.

The soft magnetic member 1M includes a weak attraction portion 10 that is a portion where the magnetic attraction force between the magnet 5 and the soft magnetic member 1M is relatively weak (small) and a strong attraction portion 11 that is a portion where the magnetic attraction force between the magnet 5 and the soft magnetic member 1M in the Y-axis direction is relatively strong (large). The strong attraction portion 11 is also referred to as a “magnetic attraction portion”.

Specifically, the left soft magnetic member 1ML includes a left weak attraction portion 10L that is a portion where the magnetic attraction force between the magnet 5 and the left soft magnetic member 1ML in the Y-axis direction is relatively weak (small) and a left strong attraction portion 11L that is a portion where the magnetic attraction force between the magnet 5 and the left soft magnetic member 1ML in the Y-axis direction is relatively strong (large).

In the state shown in FIG. 14B, when the movable member MB (magnet 5) is located at the center of the movable range, the left strong attraction portion 11L includes a first left strong attraction portion 11L1 facing the upper magnet 5U in the Y-axis direction, a second left strong attraction portion 11L2 facing the first central magnet 5C1 in the Y-axis direction, a third left strong attraction portion 11L3 facing the second central magnet 5C2 in the Y-axis direction, and a fourth left strong attraction portion 11L4 facing the lower magnet 5D in the Y-axis direction.

Similarly, a right strong attraction portion 11R includes a first right strong attraction portion 11R1 facing the upper magnet 5U in the Y-axis direction, a second right strong attraction portion 11R2 facing the first central magnet 5C1 in the Y-axis direction, a third right strong attraction portion 11R3 facing the second central magnet 5C2 in the Y-axis direction, and a fourth right strong attraction portion 11R4 facing the lower magnet 5D in the Y-axis direction.

The left weak attraction portion 10L includes a first left weak attraction portion 10L1 located above (Z1 side) the first left strong attraction portion 11L1, a second left weak attraction portion 10L2 located between the first left strong attraction portion 11L1 and the second left strong attraction portion 11L2, a third left weak attraction portion 10L3 located between the second left strong attraction portion 11L2 and the third left strong attraction portion 11L3, a fourth left weak attraction portion 10L4 located between the third left strong attraction portion 11L3 and the fourth left strong attraction portion 11L4, and a fifth left weak attraction portion 10L5 located below (Z2 side) the fourth left strong attraction portion 11L4.

Similarly, a right weak attraction portion 10R includes a first right weak attraction portion 10R1 located above the first right strong attraction portion 11R1 (Z1 side), a second right weak attraction portion 10R2 located between the first right strong attraction portion 11R1 and the second right strong attraction portion 11R2, a third right weak attraction portion 10R3 located between the second right strong attraction portion 11R2 and the third right strong attraction portion 11R3, a fourth right weak attraction portion 10R4 located between the third right strong attraction portion 11R3 and the fourth right strong attraction portion 11R4, and a fifth right weak attraction portion 10R5 located below (Z2 side) the fourth right strong attraction portion 11R4.

In the following, the first right weak attraction portion 10R1 and the first left weak attraction portion 10L1 are also referred to as an upper weak attraction portion 10U, the second right weak attraction portion 10R2 and the second left weak attraction portion 10L2 are also referred to as a first central weak attraction portion 10C1, the third right weak attraction portion 10R3 and the third left weak attraction portion 10L3 are also referred to as a second central weak attraction portion 10C2, the fourth right weak attraction portion 10R4 and the fourth left weak attraction portion 10L4 are also referred to as a third central weak attraction portion 10C3, and the fifth right weak attraction portion 10R5 and the fifth left weak attraction portion 10L5 are also referred to as a lower weak attraction portion 10D.

In the following, the first right strong attraction portion 11R1 and the first left strong attraction portion 11L1 are also referred to as an upper strong attraction portion 11U, the second right strong attraction portion 11R2 and the second left strong attraction portion 11L2 are also referred to as a first central strong attraction portion 11C1, the third right strong attraction portion 11R3 and the third left strong attraction portion 11L3 are also referred to as a second central strong attraction portion 11C2, and the fourth right strong attraction portion 11R4 and the fourth left strong attraction portion 11L4 are also referred to as a lower strong attraction portion 11D. The first central strong attraction portion 11C1 and the second central strong attraction portion 11C2 are also referred to as a central strong attraction portion 11C.

The strong attraction portion 11 may be disposed so that, in the Z-axis direction, one end is located at an inner side relative to one end of the magnet 5, or may be disposed so that the other end is located at an inner side relative to the other end of the magnet 5. The weak attraction portion 10 may include a portion extending outward relative to one end of the strong attraction portion 11, or may include a portion extending outward relative to the other end of the strong attraction portion 11 in the Z-axis direction.

In the example shown in FIG. 14B, the strong attraction portion 11 is disposed so that the upper end of the upper strong attraction portion 11U is disposed below the upper end of the upper magnet 5U and the lower end of the lower strong attraction portion 11D is disposed above the lower end of the lower magnet 5D. The weak attraction portion 10 includes the upper weak attraction portion 10U that extends above the upper end of the upper strong attraction portion 11U and the lower weak attraction portion 10D that extends below the lower end of the lower strong attraction portion 11D.

Thus, the upper weak attraction portion 10U and the lower weak attraction portion 10D are also referred to as “magnetic flux leakage suppression portions” because they are configured to suppress the leakage of the magnetic flux generated by the magnet 5 outside the linear motion device 101. Specifically, the soft magnetic member 1M is configured so that even when the movable member MB (magnet 5) moves downward (in the Z2 direction), the lower end of the lower magnet 5D is disposed above the lower end of the lower weak attraction portion 10D as shown in the central diagram in FIG. 14A, so that it is possible to suppress the leakage of the magnetic flux generated by the lower magnet 5D outside the linear motion device 101. Similarly, the soft magnetic member 1M is configured so that even when the movable member MB (magnet 5) moves upward (in the Z1 direction), the upper end of the upper magnet 5U is disposed below the upper end of the upper weak attraction portion 10U as shown in the lower diagram in FIG. 14A, so that it is possible to suppress the leakage of the magnetic flux generated by the upper magnet 5U outside the linear motion device 101. Therefore, the soft magnetic member 1M (weak attraction portion 10) can suppress noise, to other devices, caused by the magnetic flux generated by the magnet 5, which in turn has the effect of suppressing malfunctions or quality degradation of other devices.

As shown in FIG. 14B, the soft magnetic member 1M is configured so that a distance GA1 between the strong attraction portion 11 and the magnet 5 in the Y-axis direction is smaller than a distance GA2 between the weak attraction portion 10 and the magnet 5 in the Y-axis direction. This configuration has the effect that the attraction force acting between the strong attraction portion 11 and the magnet 5 can be reliably larger than the attraction force acting between the weak attraction portion 10 and the magnet 5, even when the soft magnetic member 1M (weak attraction portion 10 and strong attraction portion 11) are made of the same single material.

As shown in FIG. 14B, the soft magnetic member 1M is configured so that a thickness dimension TK1 of the weak attraction portion 10 in the Y-axis direction is smaller than a thickness dimension TK2 of the strong attraction portion 11. This configuration has the effect that the attraction force acting between the strong attraction portion 11 and the magnet 5 can be reliably larger than the attraction force acting between the weak attraction portion 10 and the magnet 5, even when the outer face of the soft magnetic member 1M (weak attraction portion 10 and strong attraction portion 11) is configured to be a flat face.

As shown in FIG. 14B, the soft magnetic member 1M is configured so that the weak attraction portion 10 and the strong attraction portion 11 are integrally formed. This configuration has the effect of reducing the number of parts, which in turn reduces the manufacturing cost of the linear motion device 101.

In the present embodiment, part of the lower magnet 5D protrudes below (in the Z2 direction) the lower end of the lower strong attraction portion 11D of the soft magnetic member 1M even when the movable member MB (magnet 5) is located at the center of the movable range, as shown in the upper diagram in FIG. 14A. Part of the upper magnet 5U protrudes above the upper end of the upper strong attraction portion 11U of the soft magnetic member 1M (in the Z1 direction) even when the movable member MB (magnet 5) is located at the center of the movable range, as shown in the upper diagram in FIG. 14A.

When the movable member MB (magnet 5) moves downward (in the Z2 direction), part of the lower magnet 5D protrudes further below the lower end of the lower strong attraction portion 11D, as shown in the central diagram in FIG. 14A. Specifically, part of the lower magnet 5D protrudes further below the lower end of the fourth right strong attraction portion 11R4 of the right soft magnetic member 1MR and further below the lower end of the fourth left strong attraction portion 11L4 of the left soft magnetic member 1ML. Since an attraction force acting between a portion 5Da, of the lower magnet 5D, that is located below the lower end of the lower strong attraction portion 11D and the lower strong attraction portion 11D is stronger than an attraction force acting between the portion 5Da of the lower magnet 5D and the lower weak attraction portion 10D, the portion 5Da is attracted upward by the lower strong attraction portion 11D.

Similarly, since an attraction force acting between a portion 5Ua located at the upper end of the upper magnet 5U and the upper strong attraction portion 11U is stronger than an attraction force acting between the portion 5Ua of the upper magnet 5U and the first central weak attraction portion 10C1, the portion 5Ua is attracted upward by the upper strong attraction portion 11U. Since an attraction force acting between a portion 5C1a, of the first central magnet 5C1, that is located below the lower end of the first central strong attraction portion 11C1 and the first central strong attraction portion 11C1 is stronger than an attraction force acting between the portion 5C1a of the first central magnet 5C1 and the second central weak attraction portion 10C2, the portion 5C1a is attracted upward by the first central strong attraction portion 11C1. Since an attraction force acting between a portion 5C2a, of the second central magnet 5C2, that is located below the lower end of the second central strong attraction portion 11C2 and the second central strong attraction portion 11C2 is stronger than an attraction force acting between the portion 5C2a of the second central magnet 5C2 and the third central weak attraction portion 10C3, the portion 5C2a is attracted upward by the second central strong attraction portion 11C2.

In the central diagram in FIG. 14A, part of the magnetic lines of force (the magnetic lines of force extending between the portion 5Da and the lower end of the lower strong attraction portion 11D) representing the magnetic field that generates the attraction force that attracts the portion 5Da of the lower magnet 5D to the lower end of the lower strong attraction portion 11D is represented by dotted lines. The same applies to the magnetic lines of force representing the magnetic field that generates the attraction force that attracts the upper magnet 5U to the lower end of the upper strong attraction portion 11U (magnetic lines of force extending between the upper magnet 5U and the lower end of the upper strong attraction portion 11U), the magnetic lines of force representing the magnetic field that generates the attraction force that attracts the first central magnet 5C1 to the lower end of the first central strong attraction portion 11C1 (magnetic lines of force extending between the first central magnet 5C1 and the magnetic lines of force extending between the lower end of the first central strong attraction portion 11C1), and the magnetic lines of force representing the magnetic field that generates the attraction force that attracts the second central magnet 5C2 to the lower end of the second central strong attraction portion 11C2 (magnetic lines of force extending between the second central magnet 5C2 and the lower end of the second central strong attraction portion 11C2). In the central diagram in FIG. 14A, for clarity, illustration of the magnetic lines of force representing other parts of the magnetic field generated by the magnet 5 is omitted.

When the movable member MB (magnet 5) moves downward (in the Z2 direction), the upper strong attraction portion 11U of the soft magnetic member 1M is disposed above the upper end of the upper magnet 5U, as shown in the central diagram in FIG. 14A. Specifically, the first right strong attraction portion 11R1 of the right soft magnetic member 1MR and the first left strong attraction portion 11L1 of the left soft magnetic member 1ML is located above the upper end of the upper magnet 5U. Since an attraction force acting between the upper magnet 5U and the upper strong attraction portion 11U is stronger than an attraction force acting between the upper magnet 5U and the first central weak attraction portion 10C1, the upper strong attraction portion 11U attracts the upper magnet 5U upward. In this state, the upper end of the upper magnet 5U is a portion, of the upper magnet 5U, that is closest to the upper strong attraction portion 11U.

Thus, the movable member MB (magnet 5) that is displaced downward from the center of the movable range receives a force (attraction force) that tries to pull the movable member MB (magnet 5) back to the center of the movable range. Therefore, the movable member MB comes to rest when the force that tries to move the movable member MB downward (driving force based on the Lorentz force) and the force that tries to pull the movable member MB back to the center of the movable range (attraction force) are balanced. The movable member MB (magnet 5) displaced downward from the center of the movable range moves upward by the attraction force and returns toward the center of the movable range when the force that tries to move the movable member MB downward is lost.

Conversely, when the movable member MB (magnet 5) moves upward (in the Z1 direction), part of the upper magnet 5U protrudes further above the upper end of the upper strong attraction portion 11U, as shown in the lower diagram in FIG. 14A. Specifically, part of the upper magnet 5U protrudes further above the upper end of the first right strong attraction portion 11R1 and protrudes further above the upper end of the first left strong attraction portion 11L1. Since an attraction force acting between a portion 5Ub, of the upper magnet 5U, that protrudes above the upper end of the upper strong attraction portion 11U and the upper strong attraction portion 11U is stronger than an attraction force acting between the portion 5Ub of the upper magnet 5U and the upper weak attraction portion 10U, the portion 5Ub is attracted downward by the upper end of the upper strong attraction portion 11U.

Similarly, since an attraction force acting between a portion 5C1b, of the first central magnet 5C1, that is located above the upper end of the first central strong attraction portion 11C1 and the first central strong attraction portion 11C1 is stronger than an attraction force acting between the portion 5C1b of the first central magnet 5C1 and the first central weak attraction portion 10C1, the portion 5C1b is attracted downward by the first central strong attraction portion 11C1. Since an attraction force acting between a portion 5C2b, of the second central magnet 5C2, that is located above the upper end of the second central strong attraction portion 11C2 and the second central strong attraction portion 11C2 is stronger than an attraction force acting between the portion 5C2b of the second central magnet 5C2 and the second central weak attraction portion 10C2, the portion 5C2b is attracted downward by the second central strong attraction portion 11C2. Since an attraction force acting between a portion 5 Db located at the lower end of the lower magnet 5D and the lower strong attraction portion 11D is stronger than an attraction force acting between the portion 5 Db of the lower magnet 5D and the third central weak attraction portion 10C3, the portion 5 Db is attracted downward by the lower strong attraction portion 11D.

In the lower diagram in FIG. 14A, part of the magnetic lines (magnetic lines of force extending between the portion 5Ub and the upper end of the upper strong attraction portion 11U) of force representing the magnetic field that generates the attraction force that attracts the portion 5Ub of the upper magnet 5U to the upper end of the upper strong attraction portion 11U is represented by dotted lines. The same applies to the magnetic lines of force representing the magnetic field that generates the attraction force that attracts the first central magnet 5C1 to the upper end of the first central strong attraction portion 11C1 (magnetic lines of force extending between the first central magnet 5C1 and the upper end of the first central strong attraction portion 11C1), the magnetic lines of force representing the magnetic field that generates the attraction force that attracts the second central magnet 5C2 to the upper end of the second central strong attraction portion 11C2 (magnetic lines of force extending between the second central magnet 5C2 and the upper end of the second central strong attraction portion 11C2), and the magnetic lines of force representing the magnetic field that generates the attraction force that attracts the lower magnet 5D to the upper end of the lower strong attraction portion 11D (magnetic lines of force extending between the lower magnet 5D and the upper end of the lower strong attraction portion 11D). In the lower diagram in FIG. 14A, for clarity, illustration of the magnetic lines of force representing other parts of the magnetic field generated by the magnet 5 is omitted.

When the movable member MB (magnet 5) moves upward (in the Z1 direction), the lower strong attraction portion 11D of the soft magnetic member 1M is disposed below the lower end of the lower magnet 5D, as shown in the lower diagram in FIG. 14A. Specifically, the fourth right strong attraction portion 11R4 of the right soft magnetic member 1MR and the fourth left strong attraction portion 11L4 of the left soft magnetic member 1ML is located below the lower end of the lower magnet 5D. Since an attraction force acting between the lower magnet 5D and the lower strong attraction portion 11D is stronger than an attraction force acting between the lower magnet 5D and the third central weak attraction portion 10C3, the lower strong attraction portion 11D attracts the lower magnet 5D downward. In this state, the lower end of the lower magnet 5D is a portion, of the lower magnet 5D, that is closest to the lower strong attraction portion 11D.

Thus, the movable member MB (magnet 5) that is displaced upward from the center of the movable range receives a force (attraction force) that tries to pull the movable member MB (magnet 5) back to the center of the movable range. Therefore, the movable member MB comes to rest when the force that tries to move movable member MB upward (driving force based on the Lorentz force) and the force that tries to pull movable member MB back to the center of the movable range (attraction force) are balanced. The movable member MB (magnet 5) displaced upward from the center of the movable range moves downward by the attraction force and returns toward the center of the movable range when the force that tries to move the movable member MB upward is lost.

Therefore, the movable member MB that is in a position off the center of the movable range is returned to the center of the movable range by the attraction force between the magnet 5 and the strong attraction portion 11 when the operation force is lost.

Referring again to FIGS. 14A, 14B, and 15, the details of the linear motion device 101 are described. The following description that refers to FIGS. 14A, 14B, and 15 relates to the state of the linear motion device 101 when no current is supplied to the coil 4. Specifically, the upper diagram in FIG. 14A, FIG. 14B, and FIG. 15 show the state of the linear motion device 101 when the movable member MB (magnet 5) is not subjected to an operation force (force to move the head member HD) by the operator. The central diagram in FIG. 14A and the central diagram in FIG. 15 show the state of the linear motion device 101 when the movable member MB (magnet 5) is subjected to a downward (in the Z2 direction) operation force (force to push down the head member HD) by the operator. The lower diagram in FIG. 14A and the lower diagram in FIG. 15 show the state of the linear motion device 101 when the movable member MB (magnet 5) is subjected to an upward (in the Z1 direction) operation force (force to pull up the head member HD) by the operator.

When the movable member MB (magnet 5) receives a downward (in the Z2 direction) operation force by the operator as shown in the central diagram in FIG. 14A and the central diagram in FIG. 15, the movable member MB (magnet 5) is guided by the guiding means GM and moves downward (in the Z2 direction) as in the case where the current flows in the left coil 4L as shown by the dashed arc arrow in the central diagram in FIG. 15.

The movable member MB (magnet 5) that is displaced downward from the center of the movable range receives a force (attraction force) that tries to pull the movable member MB (magnet 5) back to the center of the movable range. This attraction force serves as the operation reaction force F to the downward (Z2 direction) operation force (force to push down the head member HD) by the operator. In the examples shown in the central diagram in FIG. 14A and FIG. 15, the operation reaction force F to a downward (in the Z2 direction) operation force by the operator is represented by an upward (in the Z1 direction) block arrow as a force with +F1 (positive value). The movable member MB comes to rest when the force that tries to move the movable member MB downward (downward operation force by the operator) and the force that tries to pull the movable member MB back to the center of the movable range (attraction force) are balanced. The movable member MB (magnet 5) that has been displaced downward from the center of the movable range moves upward by the attraction force and returns toward the center of the movable range when the force (downward operation force by the operator) to move the movable member MB downward is lost.

When the movable member MB (magnet 5) receives an upward (in the Z1 direction) operation force by the operator as shown in the lower diagram in FIG. 14A and the lower diagram in FIG. 15, the movable member MB (magnet 5) is guided by the guiding means GM and moves upward (in the Z1 direction) as in the case where the current flows in the left coil 4L as shown by the dashed arc arrow in the lower diagram in FIG. 15.

The movable member MB (magnet 5) that is displaced upward from the center of the movable range receives a force (attraction force) that tries to pull the movable member MB (magnet 5) back to the center of the movable range. This attraction force serves as the operation reaction force F to the upward (in the Z1 direction) operation force (force to pull up the head member HD) by the operator. In the examples shown in the lower diagram in FIG. 14A and the lower diagram in FIG. 15, the operation reaction force F to an upward (in the Z1 direction) operation force by the operator is represented by a downward (in the Z2 direction) block arrow as a force with −F1 (negative value). The movable member MB comes to rest when the force to move the movable member MB upward (upward operation force by the operator) and the force to pull the movable member MB back to the center of the movable range (attraction force) are balanced. The movable member MB (magnet 5) displaced upward from the center of the movable range moves downward by the attraction force and returns toward the center of the movable range when the force (upward operation force by the operator) to move the movable member MB upward is lost.

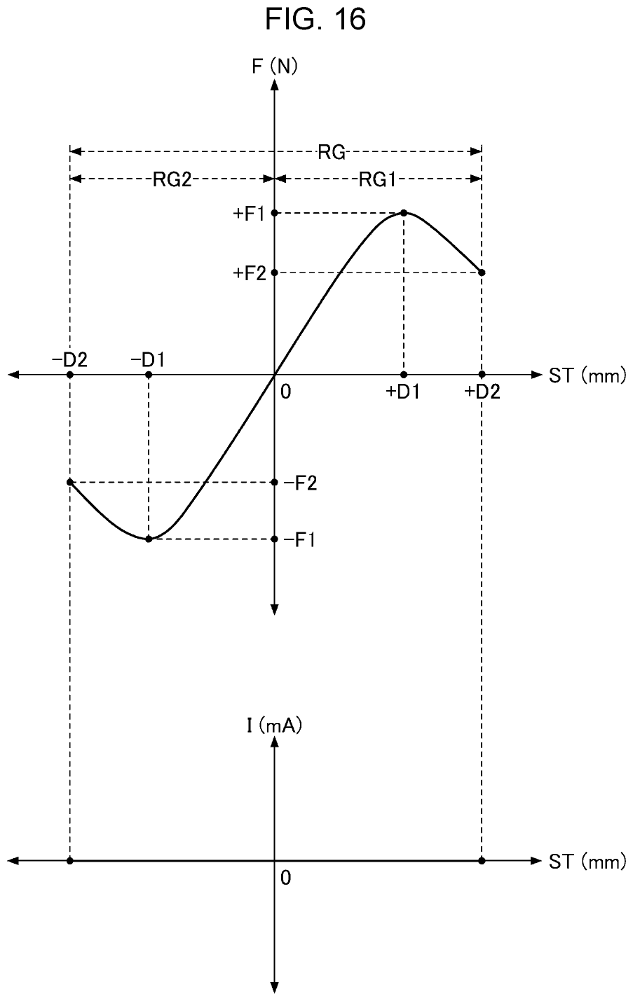

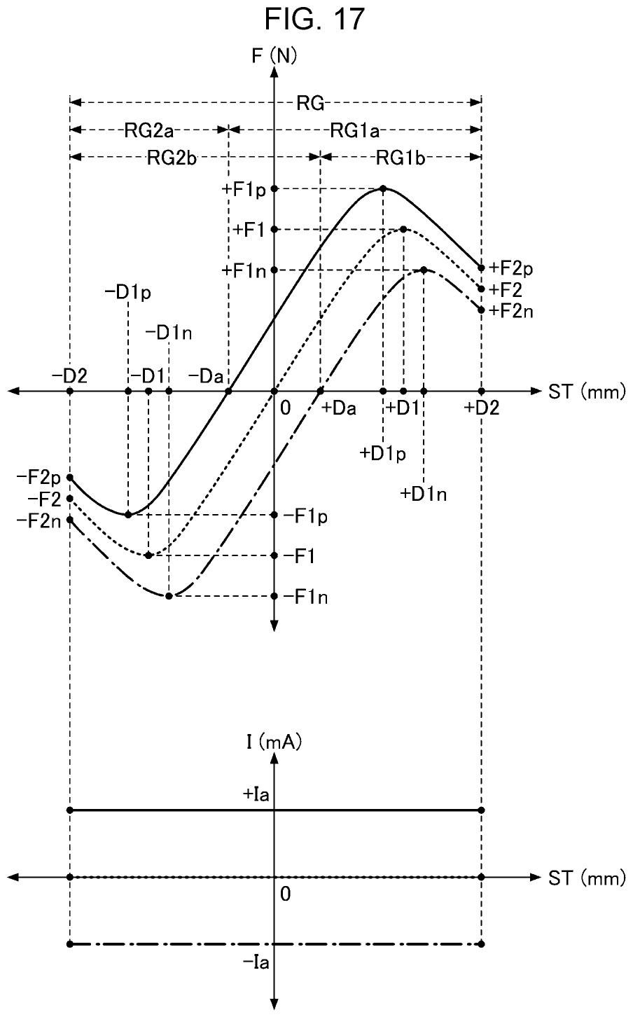

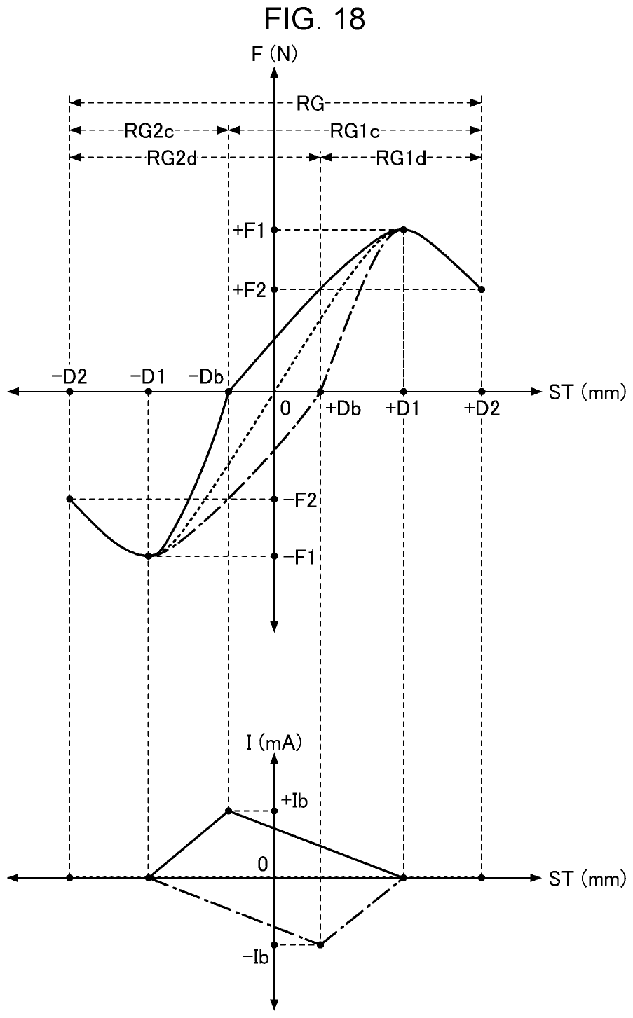

Next, referring to FIG. 16, an example of the relationship between the operation reaction force F, the stroke amount ST, and the current I is described. The operation reaction force F is an operation reaction force acting on the movable member MB. The stroke amount ST is the amount of movement of the movable member MB in the vertical direction (Z-axis direction) and is zero when the movable member MB is located at the center of the movable range (as shown in the upper diagram in FIG. 14A and the upper diagram in FIG. 15). The current I is a current flowing through the coil 4. FIG. 16 shows an example of the relationship between the operation reaction force F, the stroke amount ST, and the current I. Specifically, the upper diagram in FIG. 16 is a graph with the vertical axis as the operation reaction force F and the horizontal axis as the stroke amount ST, and the lower diagram in FIG. 16 is a graph with the vertical axis as the current I and the horizontal axis as the stroke amount ST. The horizontal axis (stroke amount ST) in the upper diagram in FIG. 16 and the horizontal axis (stroke amount ST) in the lower diagram in FIG. 16 correspond to each other. In the following description referring to FIG. 16, the operation reaction force F and the stroke amount ST when the movable member MB is pushed down are positive values, and the operation reaction force F and the stroke amount ST when the movable member MB is pulled up are negative values. Therefore, an increase in the operation reaction force F and the stroke amount ST when the movable member MB is pulled up means that their absolute values become larger, and a decrease in the operation reaction force F and the stroke amount ST when the movable member MB is pulled up means that their absolute values become smaller. The same applies to the description referring to FIGS. 17 and 18, respectively.

The relationship between the operation reaction force F and the stroke amount ST shown in the upper diagram in FIG. 16 shows the relationship when the current I is zero, that is, when no current is supplied to the coil 4, as shown in the lower diagram in FIG. 16. The upper diagram in FIG. 16 shows that the operation reaction force F is zero when the stroke amount ST is zero. The position of the movable member MB when the operation reaction force F is zero is hereinafter referred to as a “reference position”. The movable member MB is located at the reference position when the operation force by the operator is not acting on the movable member MB. The movable member MB that is not in the reference position returns to the reference position when the operation force by the operator is lost.

The upper diagram in FIG. 15 shows the left soft magnetic member 1ML, the left coil 4L, and the magnet 5 when the stroke amount ST is zero. The upper diagram in FIG. 15 shows that the stroke amount ST is zero when a measurement value MT by the position sensor 51 is MT1. In the illustrated example, the measured value MT corresponds to the distance between the magnet holder 6 and the position sensor 51.

Specifically, the upper diagram in FIG. 16 shows that the movable range of the movable member MB in the Z-axis direction has a width RG. More specifically, the upper diagram in FIG. 16 shows that a movable range when the movable member MB is pushed down has a width RG1, and a movable range when the movable member MB is pushed down has a width RG2. In the illustrated example, the width RG1 and the width RG2 have the same size.

The upper diagram in FIG. 16 shows that as the stroke amount ST increases when the movable member MB is pushed down, the operation reaction force F also increases in a generally linear fashion, and the operation reaction force F reaches +F1 (upper maximum value) when the stroke amount ST is +D1. The central diagram in FIG. 15 shows the state of the left soft magnetic member 1ML, the left coil 4L, and the magnet 5 when the stroke amount ST is +D1. The central diagram in FIG. 15 shows that the stroke amount ST is +D1 when a measurement value MT by the position sensor 51 is MT2.

The upper diagram in FIG. 16 shows that the operation reaction force F decreases in a generally linear fashion as the stroke amount ST when the movable member MB is pushed down further increases beyond +D1, and that the operation reaction force F is +F2 (upper terminal value) when the stroke amount ST reaches +D2. +D2 is the stroke amount when the downward (in the Z2 direction) movement of the movable member MB is stopped by the stopper portion. In the illustration, +D2 is the stroke amount when the lower end of the magnet holder 6 contacts the inner face (Z1 side face) of the fourth plate portion 2A4 of the casing body 2. In this case, the fourth plate portion 2A4 functions as a stopper portion.

Similarly, the upper diagram in FIG. 16 shows that the operation reaction force F also increases in a generally linear fashion as the stroke amount ST increases when the movable member MB is pulled up, and that the operation reaction force F reaches −F1 (lower maximum value) when the stroke amount ST reaches −D1. The lower diagram in FIG. 15 shows the state of the left soft magnetic member 1ML, the left coil 4L, and the magnet 5 when the stroke amount ST is −D1. The lower diagram in FIG. 15 shows that the stroke amount ST is −D1 when a measurement value MT by the position sensor 51 is MT3.

The upper diagram in FIG. 16 shows that as the stroke amount ST when the movable member MB is pulled up increases further beyond −D1, the operation reaction force F decreases in a generally linear fashion, and the operation reaction force F is −F2 (lower terminal value) when the stroke amount ST reaches −D2. −D2 is the stroke amount when the upward (in the Z1 direction) movement of the movable member MB is stopped by the stopper portion. In the illustration, −D2 is the stroke amount when the upper end portion of the magnet holder 6 contacts the inner face (Z2 side face) of the second plate portion 2A2 of the casing body 2. In this case, the second plate portion 2A2 functions as a stopper portion.

In the following, the phenomenon in which as the stroke amount ST increases, the operation reaction force F increases to the maximum value (upper maximum value or lower maximum value) and then decreases to the terminal value (upper terminal value or lower terminal value) is referred to as “snap-through buckling”. The input device ID can then give a “click” feeling to the operator by generating snap-through buckling.

Next, referring to FIG. 17, another example of the relationship between the operation reaction force F, the stroke amount ST, and the current I is described. FIG. 17 is a graph showing another example of the relationship between the operation reaction force F, the stroke amount ST, and the current I, corresponding to FIG. 16. Specifically, the upper diagram in FIG. 17 is a graph in which the vertical axis represents the operation reaction force F and the horizontal axis represents the stroke amount ST, corresponding to the upper diagram in FIG. 16. The lower diagram in FIG. 17 is a graph in which the vertical axis represents the current I and the horizontal axis represents the stroke amount ST, corresponding to the lower diagram in FIG. 16. The horizontal axis (stroke amount ST) in the upper diagram in FIG. 17 and the horizontal axis (stroke amount ST) in the lower diagram in FIG. 17 correspond to each other.

The relationship between the operation reaction force F and the stroke amount ST shown by the characteristic line in dotted line in the upper diagram in FIG. 17 shows the relationship when the current I is zero, that is, when no current is supplied to the coil 4, as shown by the dotted characteristic line in the lower diagram in FIG. 17. This relationship corresponds to the relationship shown in FIG. 16.

The relationship between the operation reaction force F and the stroke amount ST shown by the characteristic line in solid line in the upper diagram in FIG. 17 shows the relationship when the current I is +Ia, that is, when the current having a magnitude Ia flows through the coil 4 in a first energizing direction, as shown by the characteristic line in solid line in the lower diagram in FIG. 17.

The relationship between the operation reaction force F and the stroke amount ST shown by the characteristic line in dot-and-dash line in the upper diagram in FIG. 17 shows the relationship when the current I is −Ia, that is, when the current having the magnitude Ia flows through the coil 4 in the second energizing direction (opposite to the first energizing direction) as shown by the characteristic line in dot-and-dash line in the lower diagram in FIG. 17.

Specifically, the characteristic line in solid line in the upper diagram in FIG. 17 shows that when the current having the magnitude Ia flows through the coil 4 in the first energizing direction, the operation reaction force F is zero when the stroke amount ST is −Da. In other words, the characteristic line in solid line in the upper diagram in FIG. 17 shows that the movable member MB is located at the reference position when the stroke amount ST is −Da. This means that when the current having the magnitude Ia flows through the coil 4 in the first energizing direction, the movable member MB moves upward (in the Z1 direction) and the movable member MB comes to rest at the position where the stroke amount ST is −Da. This means that the movable member MB comes to rest at the position where the stroke amount ST is −Da when the operation force by the operator is not acting on the movable member MB. In this case, the movable range of the movable member MB in the Z-axis direction has a width RG same as a width RG when no current is supplied to the coil 4. However, the movable range when the movable member MB is pushed down has a width RG1a that is larger than the width RG1 when no current is supplied to the coil 4 (see the upper diagram in FIG. 16), and the movable range when the movable member MB is pulled up has a width RG2a that is smaller than the width RG2 when no current is supplied to the coil 4 (see the upper diagram in FIG. 16).

In the illustrated example, the state in which the movable member MB is stationary means that the force that tries to move the movable member MB in the Z1 direction and the force that tries to move the movable member MB in the Z2 direction are balanced. In other words, the state in which the movable member MB is at rest means the state in which the combined force of the driving force based on the Lorentz force generated by the drive means DM (coil 4 and magnet 5), the attraction force between the magnet 5 and the soft magnetic member 1M, and the operation force by the operator is zero in the Z-axis direction. When no operation force is generated, the state in which the movable member MB is at rest means the state in which the combined force of the driving force and the attraction force is zero in the Z-axis direction.

Conversely, the characteristic line in dot-and-dash line in the upper diagram in FIG. 17 shows that when the current having the magnitude Ia flows through the coil 4 in the second energizing direction, the operation reaction force F is zero when the stroke amount ST is +Da. In other words, the characteristic line in dot-and-dash line in the upper diagram in FIG. 17 shows that the movable member MB is located at the reference position when the stroke amount ST is +Da. This means that when the current having the magnitude Ia flows through the coil 4 in the second energizing direction, the movable member MB moves downward (in the Z2 direction) and the movable member MB comes to rest at the position where the stroke amount ST is +Da. This means that the movable member MB comes to rest at the position where the stroke amount ST is +Da when the operation force by the operator is not acting on the movable member MB. In this case, the movable range of the movable member MB in the Z-axis direction has a width RG same as a width RG when no current is supplied to the coil 4. However, the movable range when the movable member MB is pushed down has a width RG1b smaller than the width RG1 when no current is supplied to the coil 4 (see the upper diagram in FIG. 16), and the movable range when the movable member MB is pulled up has a width RG2b larger than the width RG2 (see the upper diagram in FIG. 16) when no current is supplied to the coil 4.

The characteristic line in solid line in the upper diagram in FIG. 17 shows that the operation reaction force F increases in a generally linear fashion as the stroke amount ST when the movable member MB is pushed down increases, as in when no current is supplied to the coil 4, and that the operation reaction force F reaches +F1p (upper maximum value) when the stroke amount ST reaches +D1p. +D1p is smaller than +D1 that is the stroke amount when the operation reaction force F is +F1 (upper maximum value) in a state where no current is supplied to the coil 4, and +F1p (upper maximum value) is greater than +F1 that is the upper maximum value of the operation reaction force F when no current is supplied to the coil 4.

The characteristic line in solid line in the upper diagram in FIG. 17 shows that the operation reaction force F decreases in a generally linear fashion as the stroke amount ST when the movable member MB is pushed down increases further beyond +D1p, as in when no current is supplied to the coil 4, and that the operation reaction force F is +F2p (upper terminal value) when the stroke amount ST reaches +D2. +F2p (upper terminal value) is greater than +F2 that is the upper terminal value when no current is supplied to the coil 4.

Similarly, the characteristic line in solid line in the upper diagram in FIG. 17 shows that the operation reaction force F increases in a generally linear fashion as the stroke amount ST when the movable member MB is pulled up increases, as in when no current is supplied to the coil 4, and that the operation reaction force F reaches −F1p (lower maximum value) when the stroke amount ST reaches −D1p. The absolute value of −D1p is larger than the absolute value of −D1 that is the stroke amount when the operation reaction force F is −F1 (lower maximum value) in a state where no current is supplied to the coil 4 and the absolute value of −F1p (lower maximum value) is smaller than the absolute value of −F1 that is the lower maximum value of the operation reaction force F when no current is supplied to the coil 4.

The characteristic line in solid line in the upper diagram in FIG. 17 shows that the operation reaction force F decreases in a generally linear fashion as the stroke amount ST when the movable member MB is pulled up increases further beyond −D1p, as in when no current is supplied to the coil 4, and the operation reaction force F is −F2p (lower terminal value) when the stroke amount ST is −D2. The absolute value of −F2p (lower terminal value) is smaller than the absolute value of −F2 that is the lower terminal value when no current is supplied to the coil 4.

Thus, the control unit CTR controls the direction and the magnitude of the current flowing through the coil 4 so that the current having the magnitude Ia flows through the coil 4 in the first energizing direction, so that it is possible to achieve the relationship between the operation reaction force F and the stroke amount ST represented by the characteristic line in solid line in the upper diagram in FIG. 17. In other words, the control unit CTR can shift the characteristic line (the characteristic line in dotted line in the upper diagram in FIG. 17) when no current is supplied to the coil 4 upward.

The characteristic line in dot-and-dash line in the upper diagram in FIG. 17 shows that the operation reaction force F also increases in a generally linear fashion as the stroke amount ST when the movable member MB is pushed down increases, as in when no current is supplied to the coil 4, and that the operation reaction force F reaches +F1n (upper maximum value) when the stroke amount ST is +D1n. +D1n is larger than +D1 that is the stroke amount when the operation reaction force F is +F1 (upper maximum value) in a state where no current is supplied to the coil 4, and +F1n (upper maximum value) is greater than +F1 that is the upper maximum value of the operation reaction force F when no current is supplied to the coil 4.

The characteristic line in dot-and-dash line in the upper diagram in FIG. 17 shows that the operation reaction force F decreases in a generally linear fashion as the stroke amount ST when the movable member MB is pushed down increases further beyond +D1n, as in when no current is supplied to the coil 4, and that the operation reaction force F is +F2n (upper terminal value) when the stroke amount ST is +D2. +F2n (upper terminal value) is smaller than +F2 that is the upper terminal value when no current is supplied to the coil 4.

Similarly, the characteristic line in dot-and-dash line in the upper diagram in FIG. 17 shows that the operation reaction force F increases in a generally linear fashion as the stroke amount ST when the movable member MB is pulled up increases, as in when no current is supplied to the coil 4, and that the operation reaction force F reaches −F1n (lower maximum value) when the stroke amount ST is −D1n. The absolute value of −D1n is smaller than the absolute value of −D1 that is the stroke amount when the operation reaction force F is −F1 (lower maximum value) in a state where no current is supplied to the coil 4, and the absolute value of −F1n (lower maximum value) is greater than the absolute value of −F1 that is the lower maximum value when no current is supplied to the coil 4.

The characteristic line in dot-and-dash line in the upper diagram in FIG. 17 shows that the operation reaction force F decreases in a generally linear fashion as the stroke amount ST when the movable member MB is pulled up increases further beyond −D1n, as in when no current is supplied to the coil 4, and that the operation reaction force F is −F2n (lower terminal value) when the stroke amount ST is −D2. The absolute value of −F2n (lower terminal value) is greater than the absolute value of −F2 that is the lower terminal value when no current is supplied to the coil 4.

Thus, the control unit CTR controls the direction and the magnitude of the current flowing through the coil 4 so that the current having the magnitude Ia flows through the coil 4 in the second energizing direction, so that it is possible to achieve the relationship between the operation reaction force F and the stroke amount ST represented by the characteristic line in dot-and-dash line in the upper diagram in FIG. 17. In other words, the control unit CTR can shift the characteristic line (the characteristic line in dotted line in the upper diagram in FIG. 17) when no current is supplied to the coil 4 downward.

Next, referring to FIG. 18, yet another example of the relationship between the operation reaction force F, the stroke amount ST, and the current I is described. FIG. 18 shows yet another example of the relationship between operation reaction force F, the stroke amount ST, and the current I, corresponding to each of FIGS. 16 and 17. Specifically, the upper diagram in FIG. 18 is a graph in which the vertical axis represents the operation reaction force F and the horizontal axis represents the stroke amount ST, corresponding to the upper figures in FIG. 16 and FIG. 17, respectively. The lower diagram in FIG. 18 is a graph in which the vertical axis represents the current I and the horizontal axis represents the stroke amount ST, corresponding to each of the lower graph in FIG. 16 and the lower graph in FIG. 17. The horizontal axis (stroke amount ST) in the upper diagram in FIG. 18 and the horizontal axis (stroke amount ST) in the lower diagram in FIG. 18 correspond to each other.

The relationship between the operation reaction force F and the stroke amount ST shown by the characteristic line in dotted line in the upper diagram in FIG. 18 shows the relationship when the current I is zero, that is, when no current is supplied to the coil 4, as shown by the dotted characteristic line in the lower diagram in FIG. 18. This relationship corresponds to the relationship shown in FIG. 16.

The relationship between the operation reaction force F and the stroke amount ST shown by the characteristic line in solid line in the upper diagram in FIG. 18 shows the relationship when the current I changes, that is, when the variable current with the maximum value +Ib flows through the coil 4 in the first energizing direction, as shown by the characteristic line in solid line in the lower diagram in FIG. 18.

The relationship between the operation reaction force F and the stroke amount ST shown by the characteristic line in dot-and-dash line in the upper diagram in FIG. 18 shows the relationship when the current I changes, that is, when the current with the maximum value Ib flows through the coil 4 in the second energizing direction (opposite to the first energizing direction) The figure shows, as shown by the characteristic line in dot-and-dash line in the lower diagram in FIG. 18.

Specifically, the characteristic line in solid line in the upper diagram in FIG. 18 shows that when the current having the magnitude Ib flows through the coil 4 in the first energizing direction, the operation reaction force F is zero when the stroke amount ST is −Db. In other words, the characteristic line in solid line in the upper diagram in FIG. 18 shows that the movable member MB is located at the reference position when the stroke amount ST is −Db. This means that when the current having the magnitude Ib flows through the coil 4 in the first energizing direction, the movable member MB moves upward (in the Z1 direction) and the movable member MB comes to rest at the position where the stroke amount ST is −Db. This means that the movable member MB comes to rest at the position where the stroke amount ST is −Db when the operation force by the operator is not acting on the movable member MB. In this case, the movable range of the movable member MB in the Z-axis direction has a width RG same as a width RG when no current is supplied to the coil 4. However, the movable range when the movable member MB is pushed down has a width RG1c that is larger than the width RG1 (see the upper diagram in FIG. 16) when no current is supplied to the coil 4, and the movable range when the movable member MB is pulled up has a width RG2c that is smaller than that of RG2 (see the upper diagram in FIG. 16) when no current is supplied to the coil 4.

Conversely, the characteristic line in dot-and-dash line in the upper diagram in FIG. 18 shows that when the current having the magnitude Ib flows through the coil 4 in the second energizing direction, the operation reaction force F is zero when the stroke amount ST is +Db. In other words, the characteristic line in dot-and-dash line in the upper diagram in FIG. 18 shows that the movable member MB is located at the reference position when the stroke amount ST is +Db. This means that when the current having the magnitude Ib flows through the coil 4 in the second energizing direction, the movable member MB moves downward (in the Z2 direction) and the movable member MB comes to rest at the position where the stroke amount ST is +Db.

This means that the movable member MB comes to rest at the position where the stroke amount ST is +Db when the operation force by the operator is not acting on the movable member MB. In this case, the movable range of the movable member MB in the Z-axis direction has a width RG same as a width RG when no current is supplied to the coil 4. However, the movable range when the movable member MB is pushed down has a width RG1d smaller than the width RG1 when no current is supplied to the coil 4 (see the upper diagram in FIG. 16), and the movable range when the movable member MB is pulled up has a width RG2d larger than the width RG2 (see the upper diagram in FIG. 16) when no current is supplied to the coil 4.

The characteristic line in solid line in the upper diagram in FIG. 18 shows that the operation reaction force F also increases in a generally linear fashion as the stroke amount ST when the movable member MB is pushed down increases, as in when no current is supplied to the coil 4, and that the operation reaction force F reaches +F1 (upper maximum value) when the stroke amount ST is +D1.

In the example shown in FIG. 18, the control unit CTR changes the magnitude of the current flowing through the coil 4 in the first energizing direction according to the output of the position sensor 51, as shown by the characteristic line in solid line in the lower diagram in FIG. 18. Specifically, the control unit CTR derives the stroke amount ST of the movable member MB based on the output of the position sensor 51, and changes the magnitude of the current according to the change in the stroke amount ST. More specifically, the control unit CTR linearly decreases the magnitude of the current flowing through the coil 4 in the first energizing direction to zero during the time when the stroke amount ST changes from −Db through zero to +D1.

The characteristic line in solid line in the upper diagram in FIG. 18 shows that the operation reaction force F decreases in a generally linear fashion as the stroke amount ST when the movable member MB is pushed down increases further beyond +D1t, as in when no current is supplied to the coil 4, and that the operation reaction force F is +F2 (upper terminal value) when the stroke amount ST is +D2. When the stroke amount ST is between +D1 and +D2, the characteristic line in solid line in the upper diagram in FIG. 18 exactly matches the characteristic line in solid line in the upper diagram in FIG. 16. When the stroke amount ST is between +D1 and +D2, the control unit CTR maintains the magnitude of the current flowing through the coil 4 at zero.

Similarly, the characteristic line in solid line in the upper diagram in FIG. 18 shows that the operation reaction force F also increases in a generally linear fashion as the stroke amount ST when the movable member MB is pulled up increases, as in when no current is supplied to the coil 4, and that the operation reaction force F reaches −F1 (lower maximum value) when the stroke amount ST is −D1.

In the example shown in FIG. 18, the control unit CTR changes the magnitude of the current flowing through the coil 4 in the first energizing direction according to the output of the position sensor 51, as shown by the characteristic line in solid line in the lower diagram in FIG. 18. Specifically, the control unit CTR derives the stroke amount ST of the movable member MB based on the output of the position sensor 51, and changes the magnitude of the current according to the change in the stroke amount ST. More specifically, the control unit CTR linearly decreases the magnitude of the current flowing through the coil 4 in the first energizing direction to zero during the time when the stroke amount ST changes from −Db to −D1.

The characteristic line in solid line in the upper diagram in FIG. 18 shows that the operation reaction force F decreases in a generally linear fashion as the stroke amount ST when the movable member MB is pulled up increases further beyond −D1, as in when no current is supplied to the coil 4, and that the operation reaction force F is −F2 (lower terminal value) when the stroke amount ST is −D2. When the stroke amount ST is between −D1 and −D2, the characteristic line in solid line in the upper diagram in FIG. 18 exactly matches the characteristic line in solid line in the upper diagram in FIG. 16. When the stroke amount ST is between −D1 and −D2, the control unit CTR maintains the magnitude of the current flowing through the coil 4 at zero.

Thus, the control unit CTR controls the magnitude of the current flowing through the coil 4 in the first energizing direction, so that it is possible to achieve the relationship between the operation reaction force F and the stroke amount ST represented by the characteristic line in solid line in the upper diagram in FIG. 18. In other words, the control unit CTR can shift the reference position of the movable member MB upward (in the Z1 direction) while maintaining the upper maximum value, the lower maximum value, the upper terminal value, and the lower terminal values of the characteristic line (the characteristic line in dotted line in the upper diagram in FIG. 18) when no current is supplied to the coil 4.

The characteristic line in dot-and-dash line in the upper diagram in FIG. 18 shows that the operation reaction force F also increases in a generally linear fashion as the stroke amount ST when the movable member MB is pushed down increases, as in when no current is supplied to the coil 4, and that the operation reaction force F reaches +F1 (upper maximum value) when the stroke amount ST is +D1.

In the example shown in FIG. 18, the control unit CTR changes the magnitude of the current flowing through the coil 4 in the second energizing direction according to the output of the position sensor 51, as shown by the characteristic line in dot-and-dash line in the lower diagram in FIG. 18. Specifically, the control unit CTR derives the stroke amount ST of the movable member MB based on the output of the position sensor 51, and changes the magnitude of the current according to the change in the stroke amount ST. More specifically, the control unit CTR linearly decreases the magnitude of the current flowing through the coil 4 in the second energizing direction to zero during the time when the stroke amount ST changes from +Db to +D1.

The characteristic line in dot-and-dash line in the upper diagram in FIG. 18 shows that the operation reaction force F decreases in a generally linear fashion as the stroke amount ST when the movable member MB is pushed down increases further beyond +D1, as in when no current is supplied to the coil 4, and that the operation reaction force F is +F 2 (upper terminal value) when the stroke amount ST is +D2. When the stroke amount ST is between +D1 and +D2, the characteristic line in dot-and-dash line in the upper diagram in FIG. 18 exactly matches the characteristic line in solid line in the upper diagram in FIG. 16. When the stroke amount ST is between +D1 and +D2, the control unit CTR maintains the magnitude of the current flowing through the coil 4 at zero.

Similarly, the characteristic line in dot-and-dash line in the upper diagram in FIG. 18 shows that the operation reaction force F increases in a generally linear fashion as the stroke amount ST when the movable member MB is pulled up increases, as in when no current is supplied to the coil 4, and that the operation reaction force F reaches −F1 (lower maximum value) when the stroke amount ST is −D1.

In the example shown in FIG. 18, the control unit CTR changes the magnitude of the current flowing through the coil 4 in the second energizing direction according to the output of the position sensor 51, as shown by the characteristic line in dot-and-dash line in the lower diagram in FIG. 18. Specifically, the control unit CTR derives the stroke amount ST of the movable member MB based on the output of the position sensor 51, and changes the magnitude of the current according to the change in the stroke amount ST. More specifically, the control unit CTR linearly decreases the magnitude of the current flowing through the coil 4 in the second energizing direction to zero during the time when the stroke amount ST changes from +Db through zero to −D1.

The characteristic line in dot-and-dash line in the upper diagram in FIG. 18 shows that the operation reaction force F decreases in a generally linear fashion as the stroke amount ST when the movable member MB is pulled up increases further beyond −D1, as in when no current is supplied to the coil 4, and that the operation reaction force F is −F2 (lower terminal value) when the stroke amount ST is −D2. When the stroke amount ST is between −D1 and −D2, the characteristic line in dot-and-dash line in the upper diagram in FIG. 18 exactly matches the characteristic line in solid line in the upper diagram in FIG. 16. When the stroke amount ST is between −D1 and −D2, the control unit CTR maintains the magnitude of the current flowing through the coil 4 at zero.

Thus, the control unit CTR controls the magnitude of the current flowing through the coil 4 in the second energizing direction, so that it is possible to achieve the relationship between the operation reaction force F and the stroke amount ST represented by the characteristic line in dot-and-dash line in the upper diagram in FIG. 18. In other words, the control unit CTR can shift the reference position of the movable member MB downward (in the Z2 direction) while maintaining the upper maximum value, the lower maximum value, the upper terminal value, and the lower terminal values of the characteristic line (the characteristic line in dotted line in the upper diagram in FIG. 18) when no current is supplied to the coil 4.

As described above, the input device ID capable of applying an operation reaction force according to the embodiment of the present disclosure includes the stationary member (housing HS), the movable member MB at least partially housed in the stationary member (housing HS) and reciprocably supported (or “reciprocatably” supported, i.e., supported in such a manner that the movable member MB can reciprocate) by the stationary member (housing HS) along a first direction (Z-axis direction), the soft magnetic member 1M fixed to the stationary member (housing HS), and the magnetic field generating member (magnet 5) fixed to the movable member MB so as to face the soft magnetic member 1M in the second direction (Y-axis direction) perpendicular to the first direction (Z-axis direction). The input device ID may include an operating member (head member HD) attached to the movable member MB outside the stationary member (housing HS), as shown in FIG. 1.

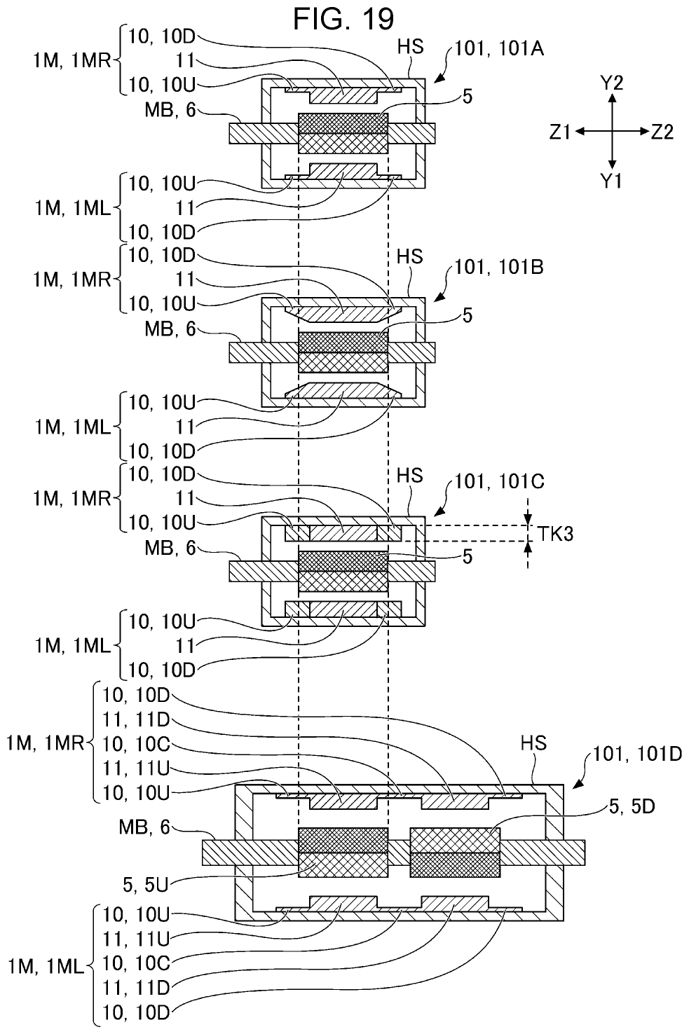

The soft magnetic member 1M includes the strong attraction portion 11 that is a portion where the magnetic attraction force between the magnetic field generating member (magnet 5) and the soft magnetic member 1M is relatively strong and the weak attraction portion 10 that is a portion where the magnetic attraction force between the magnetic field generating member (magnet 5) and the soft magnetic member 1M is relatively weak, as shown in the four examples in FIG. 19. The strong attraction portion 11 is disposed in the first direction (Z-axis direction) so that one end (Z1 side end) is located at an inner side (Z2 side) relative to one end (Z1 side end) of the magnetic field generating member (magnet 5) in the first direction (Z-axis direction), and the weak attraction portion 10 includes a portion extending outward (Z1 side) relative to one end (Z1 side end) of the strong attraction portion 11.

In the example shown in FIG. 14B, the strong attraction portion 11 is disposed so that the upper end of the upper strong attraction portion 11U is located below the upper end of the upper magnet 5U in the Z-axis direction, and the weak attraction portion 10 includes the upper weak attraction portion 10U that extends above the upper end of the upper strong attraction portion 11U in the Z-axis direction.

In the four examples shown in FIG. 19, the strong attraction portion 11 is disposed so that the upper end of the strong attraction portion 11 is located below the upper end of the magnet 5 in the Z-axis direction, and the weak attraction portion 10 includes a portion (upper weak attraction portion 10U) that extends above the upper end of the strong attraction portion 11 in the Z-axis direction.

Each of the four figures shown in FIG. 19 is a schematic cross-sectional view of the linear motion device 101 included in the input device ID, corresponding to FIG. 14b. Specifically, each of the four figures in FIG. 19 is a cross-sectional view of the stationary member (housing HS), the soft magnetic member 1M, the movable member MB (magnet holder 6), and the magnetic field generating member (magnet 5). In FIG. 19, illustration of other components is omitted for clarity. More specifically, the topmost view in FIG. 19 is a schematic cross-sectional view of a linear motion device 101A that is another configuration example of the linear motion device 101, the second view from the top in FIG. 19 is a schematic cross-sectional view of a linear motion device 101B that is yet another configuration example of the linear motion device 101, the third view from the top in FIG. 19 is a schematic cross-sectional view of a linear motion device 101C that is yet another configuration example of the linear motion device 101, the bottommost view in FIG. 19 is a schematic cross-sectional view of a linear motion device 101D that is yet another configuration example of the linear motion device 101.

The linear motion device 101A differs from the linear motion device 101 described with reference to FIGS. 1 to 18 in that the right soft magnetic member 1MR and the left soft magnetic member 1ML each have only a single strong attraction portion 11, and the magnet 5 as the magnetic field generating member is composed of a single permanent magnet. In the linear motion device 101A, the upper weak attraction portion 10U is provided at the upper part (Z1 side) of the strong attraction portion 11 and the lower weak attraction portion 10D is provided at the lower part (Z2 side) of the strong attraction portion 11.

The linear motion device 101B differs from the linear motion device 101A in that the upper weak attraction portion 10U and the lower weak attraction portion 10D have inclined faces.

The linear motion device 101C differs from the linear motion device 101A in that the weak attraction portion 10 and the strong attraction portion 11 are made of materials different from each other and that thickness dimensions TK3 of the upper weak attraction portion 10U, the strong attraction portion 11, and the lower weak attraction portion 10D are equal to each other.

The linear motion device 101D differs from the linear motion device 101A in that the right soft magnetic member 1MR and the left soft magnetic member 1ML each have two strong attraction portions 11, and that magnet 5 as a magnetic field generating member is composed of two permanent magnets.

The linear motion device 101A to the linear motion device 101D can generate snap-through buckling when the operator of the input device ID moves the movable member MB (magnet holder 6) to one end (Z1 side end) of the magnetic field generating member (magnet 5), as in the linear motion device 101 described with reference to FIGS. 1 to 18. Therefore, the input device ID including the linear motion device 101, the linear motion device 101A, the linear motion device 101B, the linear motion device 101C, or the linear motion device 101D, and the like can give the operator a click feeling when the operator moves the movable member MB (magnet holder 6) to one end (Z1 side end) of the magnetic field generating member (magnet 5).

As in the linear motion device 101 described with reference to FIGS. 1 to 18, the linear motion device 101A to the linear motion device 101D are configured so that even when the operator of the input device ID moves the movable member MB (magnet holder 6) to one end (Z1 side end) of the magnetic field generating member (magnet 5), one end of the magnetic field generating member (magnet 5) is located closer to the other end than one end of the soft magnetic member 1M. Therefore, the input device ID including the linear motion device 101, the linear motion device 101A, the linear motion device 101B, the linear motion device 101C, or the linear motion device 101D, and the like can suppress the magnetic influence of the magnetic field generating member (magnet 5) on other devices (especially other devices near one end of the input device ID) even when the operator moves the movable member MB (magnet holder 6) to one end (Z1 side end) of the magnetic field generating member (magnet 5).

The strong attraction portion 11 may be disposed so that the other end (Z2 side end) is located at an inner side (Z1 side) relative to the other end (Z2 side end) of the magnetic field generating member (magnet 5) in the first direction (Z-axis direction), and the weak attraction portion 10 may include a portion extending outward (Z2 side) relative to the other end (Z2 side end) of the strong attraction portion 11 in the first direction (Z-axis direction).

In the example shown in FIG. 14B, the strong attraction portion 11 is disposed so that the lower end of the lower strong attraction portion 11D is located above the lower end of the lower magnet 5D in the Z-axis direction, and the weak attraction portion 10 includes the lower weak attraction portion 10D that extends below the lower end of the lower strong attraction portion 11D in the Z-axis direction.

In the four examples shown in FIG. 19, the strong attraction portion 11 is disposed so that the lower end of the strong attraction portion 11 is above the lower end of the magnet 5 in the Z-axis direction, and the weak attraction portion 10 includes a portion (lower weak attraction portion 10D) that extends below the lower end of the strong attraction portion 11 in the Z-axis direction.

Therefore, as in the linear motion device 101 described with reference to FIGS. 1 to 18, the linear motion device 101A to the linear motion device 101D can generate snap-through buckling not only when the operator of the input device ID moves the movable member MB (magnet holder 6) to one end (Z1 side end) of the magnetic field generating member (magnet 5), but also when the operator of the input device ID moves the movable member MB (magnet holder 6) to the other end (Z2 side end) of the magnetic field generating member (magnet 5). Therefore, the input device ID including the linear motion device 101, the linear motion device 101A, the linear motion device 101B, the linear motion device 101C, or the linear motion device 101D, and the like can give the operator a click feeling even when the operator moves the movable member MB (magnet holder 6) to the other end (Z2 side end) of the magnetic field generating member (magnet 5).

As in the linear motion device 101 described in FIGS. 1 to 18, the linear motion device 101A to the linear motion device 101D are configured so that even when the operator of the input device ID moves the movable member MB (magnet holder 6) to the other end (Z2 side end) of the magnetic field generating member (magnet 5), the other end of the magnetic field generating member (magnet 5) is located closer to one end than the other end of the soft magnetic member 1M. Therefore, the input device ID including the linear motion device 101, the linear motion device 101A, the linear motion device 101B, the linear motion device 101C, or the linear motion device 101D, and the like can suppress the magnetic influence of the magnetic field generating member (magnet 5) on other devices (especially other devices near the other end of the input device ID) even when the operator moves the movable member MB (magnet holder 6) to the other end (Z2 side end) of the magnetic field generating member (magnet 5).

In the input device ID, the soft magnetic member 1M may be configured so that the distance GA1 between the strong attraction portion 11 and the magnetic field generating member (magnet 5) is smaller than the distance GA2 between the weak attraction portion 10 and the magnetic field generating member (magnet 5) in the second direction (Y-axis direction), as shown in FIG. 14B.

This configuration has the effect that the magnetic attraction force acting between the magnetic field generating member (magnet 5) and the strong attraction portion 11 can be larger than the magnetic attraction force acting between the magnetic field generating member (magnet 5) and the weak attraction portion 10 even when the weak attraction portion 10 and the strong attraction portion 11 are made of the same material. This is because the smaller the distance between the magnetic field generating member (magnet 5) and the soft magnetic member 1M, the greater the magnetic attraction force acting between the magnetic field generating member (magnet 5) and the soft magnetic member 1M.

As shown in the third figure from the top in FIG. 19, in a case where the weak attraction portion 10 and the strong attraction portion 11 are made of materials with different magnetic permeability, that is, in a case where the weak attraction portion 10 is made of a material with low magnetic permeability and the strong attraction portion 11 is made of a material with high magnetic permeability, the distance GA1 and the distance GA2 may be the same. This is because the magnetic attraction force acting between the magnetic field generating member (magnet 5) and the strong attraction portion 11 is greater than the magnetic attraction force acting between the magnetic field generating member (magnet 5) and the weak attraction portion 10 even when the distance between the magnetic field generating member (magnet 5) and the soft magnetic member 1M is the same.

In the input device ID, the magnetic field generating member (magnet 5) may include a first magnet (upper magnet 5U) and a second magnet (lower magnet 5D) aligned along the first direction (Z-axis direction). In this case, the strong attraction portion 11 may include the first strong attraction portion (upper strong attraction portion 11U) corresponding to the first magnet (upper magnet 5U) and the second strong attraction portion (lower strong attraction portion 11D) corresponding to the second magnet (lower magnet 5D). The weak attraction portion 10 may include a portion (central weak attraction portion 10C) that extends between the first strong attraction portion (upper strong attraction portion 11U) and the second strong attraction portion (lower strong attraction portion 11D). In this case, typically, in the Z-axis direction, the width of the first magnet (upper magnet 5U) is larger than the width of the first strong attraction portion (upper strong attraction portion 11U) and the width of the second magnet (lower magnet 5D) is larger than the width of the second strong attraction portion (lower strong attraction portion 11D).

This configuration has the effect of increasing the attraction force (operation reaction force) that acts to pull the magnetic field generating member back to a predetermined position, compared with a case where the magnetic field generating member is composed of a single magnet 5.

In the input device ID, the soft magnetic member 1M may be configured so that the thickness dimension TK1 of the weak attraction portion 10 is smaller than the thickness dimension TK2 of the strong attraction portion 11 in the second direction (Y-axis direction), as shown in FIG. 14B.

This configuration has the effect that the distance between the magnetic field generating member (magnet 5) and the strong attraction portion 11 can be smaller than the distance between the magnetic field generating member (magnet 5) and the weak attraction portion 10, while the outer faces of the soft magnetic members 1M (left face of the left soft magnetic member 1ML and right face of the right soft magnetic member 1MR) are flush (flat face).

In the input device ID, the weak attraction portion 10 may be integrally formed with the strong attraction portion 11. This configuration has the effect of increasing the strength of the soft magnetic member 1M. This configuration also has the effect of reducing the number of components, which in turn reduces the manufacturing cost of the input device ID.

The preferred embodiments of the present disclosure are described in detail. However, the invention is not limited to the embodiments described above. Various variations or substitutions may be applied to the above-described embodiments without departing from the scope of the invention. Each of the features described with reference to the embodiments above may also be combined as appropriate, as long as it is not technically inconsistent.

For example, in the embodiment described above, the soft magnetic member 1M is provided on both sides (left side and right side) of the movable member MB, but it may be provided on only one side (left side or right side). The same applies to the coil 4. Each of the coils 4 on both sides of the movable member MB may be omitted.

What is claimed is:

1. An input device capable of applying an operation reaction force, the input device comprising:
a stationary member;
a movable member at least partially housed in the stationary member and reciprocably supported by the stationary member along a first direction;
a soft magnetic member fixed to the stationary member; and
a magnetic field generating member fixed to the movable member so as to face the soft magnetic member in a second direction perpendicular to the first direction, wherein
the soft magnetic member includes a strong attraction portion where a magnetic attraction force between the magnetic field generating member and the soft magnetic member is relatively strong and a weak attraction portion where a magnetic attraction force between the magnetic field generating member and the soft magnetic member is relatively weak, wherein
the strong attraction portion is disposed so that one end of the strong attraction portion is located at an inner side relative to one end of the magnetic field generating member in the first direction, and wherein
the weak attraction portion includes a portion extending outward relative to the one end of the strong attraction portion in the first direction.

2. The input device according to claim 1, wherein
the strong attraction portion is disposed so that the other end of the strong attraction portion is located at an inner side relative to the other end of the magnetic field generating member in the first direction, and wherein
the weak attraction portion includes a portion extending outward relative to the other end of the strong attraction portion in the first direction.

3. The input device as claimed in claim 1, wherein
a distance between the strong attraction portion and the magnetic field generating member is smaller than a distance between the weak attraction portion and the magnetic field generating member in the second direction.

4. The input device as recited in claim 1, wherein
the magnetic field generating member includes a first magnet and a second magnet aligned along the first direction, wherein
the strong attraction portion includes a first strong attraction portion corresponding to the first magnet and a second strong attraction portion corresponding to the second magnet, and wherein
the weak attraction portion includes a portion extending between the first strong attraction portion and the second strong attraction portion.

5. The input device as claimed in claim 1, wherein
a thickness dimension of the weak attraction portion is smaller than a thickness dimension of the strong attraction portion in the second direction.

6. The input device as claimed in claim 1, wherein
the weak attraction portion is integrally formed with the strong attraction portion.
